(19) United States
(12) Patent Application Publication
(10) Pub. No.: US 2021/0309947 A1
(43) Pub. Date: Oct. 7, 2021

(54) WATER-SOLUBLE POLYMER FILMS OF ETHYLENE OXIDE HOMO- OR COPOLYMERS, CALENDERING PROCESS FOR THE PRODUCTION THEREOF AND THE USE THEREOF

(71) Applicant: BASF SE, Ludwigshafen am Rhein (DE)

(72) Inventors: Lukas Wengeler, Ludwigshafen (DE); Anja Thomas, Ludwigshafen (DE); Benjamin Schmidt-Hansberg, Ludwigshafen (DE); Juergen Detering, Ludwigshafen (DE); Robert Parker, Ludwigshafen (DE)

(21) Appl. No.: 17/267,540

(22) PCT Filed: Aug. 15, 2019
(86) PCT No.: PCT/EP2019/071943

§ 371 Date: Feb. 10, 2021

(30) Foreign Application Priority Data
Aug. 16, 2018 (EP) 18189350.4

(51) Int. Cl. C11D 17/04; C08J 5/18; C11D 11/00; C11D 3/37; C11D 3/34; C11D 3/04; C11D 3/22; C11D 1/72; B29C 43/24; B29C 43/00; B65D 65/46

(52) U.S. Cl. CPC C11D 17/042; C08J 5/18; C11D 11/0023; C11D 3/3707; C11D 3/3761; C11D 3/3427; B29K 2071/02; C11D 3/225; C11D 1/72; B29C 43/24; B29C 43/003; B65D 65/46; C08J 2371/02; C11D 3/046

(57) ABSTRACT

Described herein is a process for producing water soluble polymer films by low temperature calendering of a polymer composition including an ethylene oxide homo- or copolymer. Also described herein are polymer films obtainable by said process and methods of using the polymer films, in particular for the portionwise packaging of detergents and cleaners.

### BACKGROUND OF THE INVENTION

The present invention relates to a process for the production of water soluble polymer films by low temperature calendering of a polymer composition comprising an ethylene oxide homo- or copolymer. The invention furthermore relates to the polymer films obtainable by said process and the use thereof, in particular for the portionwise packaging of detergents and cleaners.

### PRIOR ART

It is known to use water-soluble films of polyvinyl alcohol for the portionwise packaging of liquid, gel-like and solid detergents and cleaners. The polyvinyl alcohol film dissolves at the start of the washing and cleaning process and releases the detergents and cleaners so that these can develop their effect. The advantages of the portionwise packaged detergents and cleaners (so-called single dose units or mono dose units) for the consumer are manifold. These include the avoidance of incorrect dosages, ease of handling, and the fact that the consumer does not come into physical contact with the ingredients of the detergents and cleaners. Furthermore, aesthetic aspects lead to a preference of portionwise packaged detergents and cleaners. Current dosage forms can comprise a large number of separately formulated active ingredients and auxiliaries which are released individually in the cleaning process. Such multichamber systems permit, for example, the separation of incompatible ingredients and thus the creation of new formulation concepts.

Polymer films can be produced e.g. by extrusion, film casting (from solution or melt) or calendering. Calendering is a long established process for the manufacture of films and sheets of thermoplastic polymers. During calendering the polymer composition is passed through a series of nips formed by a number of heated cooperating rolls to form a continuous film, sheet, or web of specified width and thickness. The resulting film is wound into large rolls as finished products or for additional processing steps. Usually the polymer raw material is subjected to a melting or plastification prior to the calendering, e.g. by extrusion. During calendering, the polymer film is subjected to longitudinal and transverse stresses developed during removal of the film from the final roll of the calender stack and during winding of the finished rolls of film.

On an industrial scale film calendering is only used for the production of films from few classes of polymers such as polyvinyl chloride. Water soluble films made from polyvinyl alcohol, e.g. for packaging applications, are typically prepared either by extrusion and film blowing or solution casting. Whereas the process costs of blow films are typically low, the film quality is often insufficient for high performance applications. Thus, water soluble foils for unit dose packaging are produced primarily by a high cost solution casting of polyvinyl alcohol.

U.S. Pat. No. 3,004,296 describes a method for producing a polyethylene oxide which comprises fluxing (bringing to a confluent state in which there is exhibited plastic flow) an ethylene oxide homopolymer resin having a viscosity in the range of from about 1000 to 40000 centipoise. The fluxed resin is successively passed through the nips between each adjacent pair of a series of at least three counter-rotating surfacing rolls while maintaining the last roll and the penultimate roll at a temperature of from about 70 to 95° C., wherein the last roll has a higher temperature than the penultimate roll and the antepenultimate roll has a temperature from about 20 to 50° C. higher than the penultimate roll. The polymer can be brought to a confluent state either by extrusion or in the calender itself by rolls with a high temperature upstream of the true calendering rolls. After calendering the formed film is subjected to a rapid chilling to a temperature below about 30° C. The obtained films exhibit a good resistance to constant strain cracking or rupture and can be employed as water-soluble packaging material.

U.S. Pat. No. 3,328,503 describes a process for the manufacture of crystalline oriented films and sheets by mechanically induced crystallization of a molten amorphous thermoplastic polymer in a calender. The polymer can inter alia be a homopolymer or copolymer of ethylene oxide, propylene oxide, butylene oxide and styrene oxide.

U.S. Pat. No. 3,377,261 describes a biaxially oriented, water-soluble ethylene oxide polymer film produced by a process comprising: (a) forming an ethylene oxide polymer film, (b) subjecting the film to high energy radiation, (c) heating the irradiated polymer film to an orientation temperature and stretching the film, and (d) rapidly quenching the stretched film under tension. The film temperature during stretching is preferably in a range of from about 10° C. above the melting point to about 30° C. below the melting point of the film.

U.S. Pat. No. 3,465,070 describes a method for improving the properties of a conventionally prepared polyethylene oxide film by a cold rolling process which involves high levels of nip pressure and web tension, achieved by passing the film through compression rolls that are both compressed simultaneously. The starting material of the cold roll process is a polymer film that already results from a conventional calendaring at higher temperatures. The obtained polymer films are characterized by a good elasticity but the tensile strength is still worth of improvement.

JP 2001276597 describes citric acid granulated powder which is coated with polyethylene glycol. The granulated powder and the polyethylene glycol are heated and mixed at a temperature less than the melting point of polyethylene glycol. Thereby a coat is formed around the citric acid particles. In other words, the coated granulated powder is a separate powder particle. The described coat is not a polymer film which has a flat structure, which has an essentially two-dimensional extension.

There is an ongoing demand for a process that allows the production of water-soluble polymer films with a specific property profile that leads to portion-wise packagings, e.g. for detergents and cleaners, with good application properties at moderate costs.

Surprisingly, it has now been found that it is possible to provide water soluble polymer films on the basis of polyethylene oxide which are advantageously suitable as covering or coating for producing detergent or cleaner portions. In the process of the invention a polymer composition comprising an ethylene oxide homo- or copolymer is subjected to a solid-state film formation process. This process results in polymer films with advantageous mechanical properties caused by orientation of the polymers under high shear forces and at low relaxation times. This is a crucial difference to all conventional processes, wherein the polyethylene oxide resin is at some point brought in a confluent state by dissolution or melting. Consequently, in the conventional processes less shear force is required for the deformation of the polymer material and the relaxation times during solidification of the confluent polymer material are longer. The films are advantageous with regard to at least one of the following properties: mechanical strength, dissolution properties, barrier properties, optic and haptic properties. Generally, it is possible to provide films with a better application profile than films of the prior art on the basis of conventional polyethylene oxide.

### SUMMARY OF THE INVENTION

A first object of the invention is a process for producing a water-soluble or water-dispersible polymer film, in which
a) a polymer composition in powder or granular form comprising or consisting of a water-soluble ethylene oxide homo- or copolymer P1) is provided,
b) the polymer composition provided in step a) is subjected to a calendering at a temperature below the melting point of the ethylene oxide homo- or copolymer P1) and sustantially absent any extraneous solvent to obtain a polymer film.

A further object of the invention is a polymer film obtainable by a process as defined above and below, preferably a polymer film obtainable by a process as defined above and below which has a flat structure having an essentially two-dimensional extension, especially a polymer film obtainable by a process as defined above and below having a tensile strength in the range from 3 to 150 N/mm² (3 to 100 MPa).

A further object of the invention is the use of a polymer film as defined above and in the following
as a washing and cleaning composition,
for at least partial coating or ensheathing of washing and cleaning compositions,
as a dishwashing composition or as a rinse aid,
for at least partial coating or ensheathing of dishwashing compositions or for at least partial coating or ensheathing of rinse aids,
as hygiene products,
for at least partial coating or ensheathing of hygiene products,
as disinfectants,
for at least partial coating or ensheathing of disinfectants,
for at least partial coating or ensheathing of personal care compositions,
for at least partial coating or ensheathing of personal cleansing compositions,
for at least partial coating or ensheathing of cosmetic compositions,
as pharmaceutical compositions,
for at least partial coating or ensheathing of pharmaceutical compositions,
as crop protection compositions,
for at least partial coating or ensheathing of crop protection compositions,
for at least partial coating or ensheathing of bait traps,
as food or animal feed packaging,
as wetting agents,
for at least partial coating or ensheathing of wetting agents,
as packaging for textiles,
as lamination films,
in composite systems (laminates) such as composite glass.

A further object of the invention is a sheath or coating for a washing composition portion, cleaning composition portion or dishwashing composition portion, comprising or consisting of a polymer film as defined above and in the following.

A further object of the invention is a washing or cleaning composition comprising:
A) at least one sheath and/or coating comprising or consisting of a polymer film as defined above and in the following,
B) at least one surfactant,
C) optionally at least one builder,
D) optionally at least one bleach system,
E) optionally at least one further additive, preferably selected from enzymes, bases, corrosion inhibitors, defoamers, dyes, fragrances, fillers, tableting aids, disintegrants, thickeners, solubilizers, organic solvents, electrolytes, pH modifiers, perfume carriers, fluorescers, hydrotropes, antiredeposition agents, optical brighteners, graying inhibitors, antishrink agents, anticrease agents, dye transfer inhibitors, antimicrobial active ingredients, antioxidants, polymeric dispersants, antistats, ironing aids, hydrophobizing and impregnating agents, antiswell and antislip agents and UV absorbers, and
F) optionally water.

A further object of the invention is a dishwashing composition comprising:
Ga) at least one sheath and/or coating comprising or consisting of a polymer film as defined above and in the following,
Gb) optionally at least one complexing agent,
Gc) at least one builder and/or cobuilder,
Gd) at least one nonionic surfactant,
Ge) optionally at least one component selected from bleaches, bleach activators and bleach catalysts,
Gf) optionally at least one enzyme,
Gg) optionally at least one further additive, preferably selected from anionic or zwitterionic surfactants, alkali carriers, polymeric dispersants, corrosion inhibitors, defoamers, dyes, fragrances, fillers, tablet disintegrants, organic solvents, tableting aids, disintegrants, thickeners and solubilizers,
Gh) optionally water.

### DESCRIPTION OF THE INVENTION

A water-soluble polymer film in the sense of the invention has a solublity of at least 1 g polymer in 1 L water at 25° C. If the polymer films according to the invention are not water-soluble, they can easily be dispersed in water at 25° C. Usually, dispersion is possible without the aid of high shearing forces, e.g. simply by stirring, so that high speed stirrers or co-solvents having an emulsifying action need not be used for the preparation of dispersions from the polymer films according to the invention. Generally, the dispersions contain no precipitates or ground sediment even after they have been left to stand for more than 24 hours.

In the sense of the invention the terms “powder” and “granulars” both denote a system of a disperse solid phase and a continuous gaseous phase. Powder refers to materials that have the finer grain sizes, whereas granulars refers to the coarser materials, the terms not being mutually exclusive. The solid phase consists of fine dispersed particles (solids) present as macroscopic heap or bulk. When at rest, the particles touch each other and thus determine the powder technological properties. In the present invention a part of the volume of the gaseous phase between the particles (voids) may be replaced by a liquid. Preferably, at most 90%, more preferably at most 75%, in particular at most 50% of the volume of the gaseous phase between the particles (voids) may be replaced by a liquid. In a special embodiment the polymer composition in powder or granular form does not contain any liquid components.

The polymer composition in powder or granular form preferably flows freely when shaken or tilted.

In step b), the polymer composition provided in step a) is subjected to a calendering substantially absent any extraneous solvent. The calendering is preferably carried out in the complete absence of an added solvent. However, it is possible that the polymer composition contains small amounts of liquid components that act primarily not as a solvent but as an additive to modify certain properties of the polymer composition and/or the resulting polymer film. For example, the polymer composition may contain a liquid plasticiser, like glycerine. In any case, the polymer composition is in a form of a powder having a lower content of liquid components than a paste (being a suspension of a solid material in a liquid) or a slurry (being a mixture of a solid material with a liquid, wherein the mixture owes its flowability because of the high liquid content).

The polymer films according to the invention or produced by the process according to the invention are suitable for the portionwise packaging of liquid, gel-like and solid detergents and cleaners. They dissolve at the start of the particular application (e.g. in the washing or dishwashing water), thus release the ingredients of the detergents and cleaners.

In the context of the present invention, the terms “detergent portion” and “cleaner portion” are understood as meaning an amount of a detergent or of a cleaner that suffices for a washing or cleaning operation taking place in an aqueous phase. This may for example be a machine washing operation, as is carried out using standard commercial washing machines. According to the invention, this term is also understood as meaning an active ingredient portion for a hand wash operation or a cleaning operation carried out by hand (as is carried out, e.g., in a hand washing basin or in a bowl). The washing- and cleaning-active polymer films according to the invention are preferably used for producing active ingredient portions for machine washing or cleaning operations.

In the context of the present invention, the term “polymer film” refers to a flat structure which has an essentially two-dimensional extension. The thickness of the films according to the invention is preferably 0.5 μm to 20 mm, more preferably 1 μm to 10 mm, in particular 5 μm to 500 μm. The thickness of the polymer films of the invention is small in relation to the length and width. Preferably, the thickness of the polymer films is smaller by a factor of at least 2 and especially of at least 10 than the length of the greatest longitudinal axis. In a specific embodiment, the thickness of the polymer films is smaller by a factor of at least 50, more specifically at least 100 and very specifically at least 500 than the length of the greatest longitudinal axis. In principle, the upper value for the greatest longitudinal extent of the polymer films of the invention is uncritical. The polymer films of the invention can be produced, for example, in the form of film rolls, where the greatest length may even be in the region of 100 m or higher.

The polymer films of the invention can be in form of single layer films or multilayer films.

For the purpose of the invention, the article “a” and “an” preceding an element does not exclude the presence of a plurality of such elements.

In the context of this application, compounds which can be derived from acrylic acid and methacrylic acid are sometimes referred to by adding the syllable “(meth)” to the compound derived from acrylic acid.

Suitable C₁-C₄-alkyl groups, C₁-C₇-alkyl groups, C₈-C₁₈-alkyl groups and C₁₂-C₁₈-alkyl groups are in each case linear and (above 3 carbon atoms) branched alkyl groups.

In the context of the present invention, C₁-C₄-alkyl is a linear or branched alkyl radical having 1 to 4 carbon atoms. Suitable C₁-C₄-alkyls are methyl, ethyl, n-propyl, isopropyl, n-butyl, sec-butyl, isobutyl and tert-butyl.

In the context of the present invention, C₁-C₇-alkyl is a linear or branched alkyl radical having 1 to 7 carbon atoms. Suitable C₁-C₇-alkyls are methyl, ethyl, propyl, isopropyl, n-butyl, sec-butyl, isobutyl, tert-butyl, n-pentyl, n-hexyl, n-heptyl and constitutional isomers thereof.

C₁₂-C₁₈-alkyl is a linear or branched alkyl radical having 12 to 18 carbon atoms. Suitable C₁₂-C₁₈-alkyls are dodecyl, tridecyl, tetradecyl, pentadecyl, hexadecyl, heptadecyl, octadecyl, nonadecyl, eicosyl, henicosyl, docosyl, tricosyl, tetracosyl and constitutional isomers thereof. In a preferred embodiment, they are predominantly linear C₁₂-C₁₈-alkyl radicals, as also occur in natural or synthetic fatty alcohols, and oxo alcohols.

C₈-C₁₈-alkyl is a linear or branched alkyl radical having 8 to 18 carbon atoms. Suitable C₈-C₁₈-alkyls are octyl, 2-ethylhexyl, nonyl, decyl, 2-propylheptyl, undecyl, dodecyl, tridecyl, tetradecyl, pentadecyl, hexadecyl, heptadecyl, octadecyl, nonadecyl, eicosyl, henicosyl, docosyl, tricosyl, tetracosyl and constitutional isomers thereof. In a preferred embodiment, they are predominantly linear C₈-C₁₈-alkyl radicals, as also occur in natural or synthetic fatty alcohols, and oxo alcohols.

In the context of the present application, the expression C₉C₁₁-alcohols is a mixture which comprises alcohols having 9 carbon atoms and alcohols having 11 carbon atoms. C₁₂C₁₄-alcohols are a mixture which comprises alcohols having 12 carbon atoms and alcohols having 14 carbon atoms. C₁₃C₁₅-alcohols are a mixture which comprises alcohols having 13 carbon atoms and alcohols having 15 carbon atoms. C₁₂C₁₈-alcohols are a mixture which comprises alcohols having 12 carbon atoms, alcohols having 14 carbon atoms, alcohols having 16 carbon atoms and alcohols having 18 carbon atoms.

In step a) of the process according to the invention a polymer composition in powder form comprising or consisting of an ethylene oxide homo- or copolymer P1) is provided.

### Ethylene Oxide Homo- or Copolymer P1)

Suitable ethylene oxide homo- or copolymers P1) and methods for their production are generally known. They can be prepared e.g. by anionic, ring-opening polymerization of ethylene oxide and (in the case of copolymers) further alkylene oxides with alcohols as initiators (see Ullmann Encyclopedia of Industrial Chemistry 5. ed VCH, ISBN 3-527-20100-9). For copolymers the molecular addition can be carried out by the block method, i.e. only one alkylene oxide is added at a time. The polyether alcohols prepared in this way have polyether chains in which segments of one alkylene oxide are arranged in sequence. A further possible way of preparing polyether alcohols from at least two alkylene oxides is the random, also known as heteric, molecular addition of the alkylene oxides. Here, the alkylene oxides are metered into the reaction mixture in the form of a mixture.

In a preferred embodiment, the polymer P1) is an ethylene oxide homopolymer (polyethylene oxide).

If the polymer P1) is an ethylene oxide copolymer, it comprises in polymerized form ethylene oxide and at least one comonomer, preferably selected from 1,2-propylene oxide, 1,2-butylene oxide, 2,3-butylene oxide, 1,2-pentylene oxide, tetrahydrofurane, styrene oxide and mixtures thereof. Preferably, polymer P1) is a copolymer of ethylene oxide and propylene oxide.

If the polymer P1) is an ethylene oxide copolymer, the amount of alkylene oxides different from ethylene oxide is preferably 0.01 to 50 wt.-%, more preferably 0.1 to 25 wt.-%, in particular 0.5 to 10 wt.-%, based on the total weight of ethylene oxide and the alkylene oxide comonomers.

If the polymer P1) is an ethylene oxide copolymer, the alkylene oxide comonomers different from ethylene oxide are chosen in an amount that the resulting copolymer is still water-soluble, i.e. at least 1 g polymer are soluble in 1 L water at 20° C.

Suitable ethylene oxide copolymers are random or block copolymers.

The given particle sizes and particle size distributions are based on results from sieve analysis which can be performed according to DIN 66165:2016-08. The polymer P1) is fractionated using several sieves by mechanical sieving in pre-calibrated systems. Unless specified otherwise, the percentages given in connection with the particle sizes are weight percent. The used metrics when describing particle size distributions obtained by sieve analysis are D-Values, e.g. D10, D50 and D90, which are the intercepts for 10%, 50% and 90% of the cumulative mass. For example the D10 is the diameter at which 10% of the sample's mass is comprised of particles with a diameter less than this value. The D50 is the diameter of the particle that 50% of a sample's mass is smaller than and 50% of a sample's mass is larger than (also denoted as the mean weight particle size). The D90 is the diameter at which 90% of the sample's mass is comprised of particles with a diameter less than this value.

Preferably, the ethylene oxide homo- or copolymer P1) employed in step a) has a D50 value from 100 μm to 750 μm.

Preferably, the ethylene oxide homo- or copolymer P1) employed in step a) has a D90 value of at most 5 mm, more preferably at most 1 mm.

Preferably, the ethylene oxide homo- or copolymer P1) employed in step a) has a number-average molecular weight in the range from 10000 to 10000000 g/mol, more preferably 25000 to 5000000 g/mol, in particular 100000 to 1000000 g/mol. The number-average molecular weight M_{W} of the polymer P1) can be determined by means of gel permeation chromatography (GPC) in aqueous solution using neutralized polyacrylic acid as polymer standard.

### Polymer Component P2)

For adjusting the mechanical properties and/or the dissolution properties of the polymer films of the invention, it is possible to employ a polymer composition in step a) that comprises a mixture of polymer components. The polymer components used in the mixture may differ in terms of their chemical composition and/or in terms of their physicochemical properties (e.g. in terms of their molecular weight). In a preferred embodiment, the polymer composition comprises at least one polymer component P1) and at least one polymer component P2) having a different chemical composition.

The polymer components P2) as mentioned in the following are also suitable for the formation of multilayer films.

Preferably, the polymer composition provided in step a) further comprises a polymer component P2) selected from
polymer compositions obtainable by free-radical polymerization of a monomer composition M) which comprises at least one monomer A) selected from α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether PE) having an average of 3 to 12 alkylene oxide units per molecule,
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid, especially copolymers comprising at least one copolymerized acrylic monomer selected from acrylic acid, acrylic salts and mixtures thereof, and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
copolymers comprising at least one copolymerized maleic monomer selected from maleic acid, maleic anhydride, maleic salts and mixtures thereof and at least one copolymerized C₂-C₈ olefin,
homo- and copolymers comprising at least one monomer comprising sulfonic acid groups,
homo- and copolymers of acrylamide and/or methacrylamide,
polyamino acids,
water-soluble or water-dispersible polyamides,
polyalkylene glycols, mono- or diethers of polyalkylene glycols, each being different from P1), and
mixtures thereof.

In particular, the polymer composition provided in step a) further comprises a polymer component P2) selected from
polymer compositions obtainable by free-radical polymerization of a monomer composition M) which comprises at least one monomer A) selected from α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether PE) having an average of 3 to 12 alkylene oxide units per molecule,
cellulose ethers and cellulose esters,
homo- and copolymers comprising repeat units which derive from vinyl alcohol, vinyl esters, alkoxylated vinyl alcohols or mixtures thereof,
polymers selected from polyvinylpyrrolidone homopolymers, polyvinylimidazole homopolymers, copolymers comprising copolymerized vinylpyrrolidone and vinylimidazole, polyvinylpyridine N-oxide, poly-N-carboxymethyl-4-vinylpyridium halides,
mixtures thereof.

In one embodiment, the polymer composition provided in step a) comprises a polymer component P2) selected from polymer compositions obtainable by free-radical polymerization of a monomer composition M) which comprises at least one monomer A) selected from α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether PE) having an average of 3 to 12 alkylene oxide units per molecule. Suitable polymer compositions of this type are described e.g. in WO2017/158002, which is incorporated herein by reference.

### Monomer Composition M)

### Monomer A)

The monomer composition M) comprises at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof.

In a specific embodiment, the monomer composition M) consists solely of α,β-ethylenically unsaturated carboxylic acids, salts of α,β-ethylenically unsaturated carboxylic acids and mixtures thereof.

The α,β-ethylenically unsaturated carboxylic acid is preferably selected from acrylic acid, methacrylic acid and mixtures thereof. Suitable salts of the aforementioned acids are especially the sodium, potassium, calcium, magnesium and ammonium salts, and the salts with amines, preferably alkanolamines such as ethanolamine, diethanolamine and triethanolamine. The monomers A) can be used as such or as mixtures with one another. The stated proportions by weight all refer to the acid form.

In a specific embodiment, exclusively acrylic acid is used as monomer A).

Monomer A) is used preferably in an amount of 50% to 100% by weight, more preferably 60% to 100% by weight, based on the total weight of the monomer composition M).

In a preferred embodiment, the monomer composition M) consists to an extent of at least 50% by weight, preferably to an extent of at least 80% by weight and especially to an extent of at least 90% by weight, based on the total weight of the monomer composition M), of acrylic acid and/or acrylic acid salts.

### Monomer B)

The monomer composition M) may, in addition to the monomers A), comprise at least one monomer B) selected from unsaturated sulfonic acids, salts of unsaturated sulfonic acids, unsaturated phosphonic acid, salts of unsaturated phosphonic acids and mixtures thereof.

Monomer B) is preferably selected from 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, vinylphosphonic acid, allylphosphonic acid, salts of the aforementioned acids and mixtures thereof.

A preferred monomer B) is 2-acrylamido-2-methylpropanesulfonic acid.

Suitable salts of the aforementioned acids are especially the sodium, potassium and ammonium salts, and the salts with amines. The monomers B) can be used as such or as mixtures with one another. The stated proportions by weight all refer to the acid form.

Preferably, the monomer composition M) in that case consists to an extent of at least 50% by weight, more preferably to an extent of at least 80% by weight and especially to an extent of at least 90% by weight, based on the total weight of the monomer composition M), of monomers A) and B). When the monomer composition M) comprises at least one monomer B), it is preferably used in an amount of 0.1% to 50% by weight, more preferably 1% to 25% by weight, based on the total weight of the monomer composition M).

### Further Monomers C)

The monomer composition M) may additionally comprise at least one further monomer other than the monomers containing acid groups and salts thereof (=monomer C).

The monomer composition M) may thus have the following monomer compositions: A) or A)+B) or A)+C) or A)+B)+C).

Preferably, the at least one monomer C) is selected from

C1) nitrogen heterocycles having a free-radically polymerizable α,β-ethylenically unsaturated double bond, preferably selected from 1-vinylimidazole, 2-vinylpyridine, 4-vinylpyridine, 2-allylpyridine, 4-allylpyridine and the salts thereof obtained by protonation or by quaternization,
C2) monomers containing amide groups, preferably selected from N-vinylpyrrolidone, N-vinylcaprolactam, acrylamide, methacrylamide, N-vinylformamide, N-vinylacetamide and mixtures thereof.
C3) compounds of the general formulae (I.a) and (I.b)

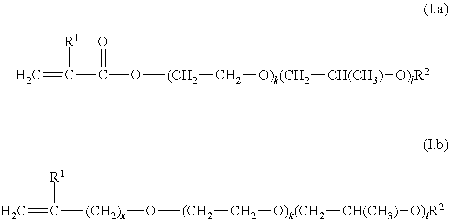

in which
the sequence of the alkylene oxide units is arbitrary,
x is 0, 1 or 2,
k and l are independently an integer from 0 to 100, where the sum of k and l is at least 2, preferably at least 5,
R¹ is hydrogen or methyl,
R² is hydrogen, C₁-C₄-alkyl,
and mixtures of two or more than two of the afore-mentioned monomers C1) to C3).

Specifically, the monomer composition M) comprises 1-vinylimidazole as comonomer C1).

In a further special embodiment, the monomer composition M) comprises at least one comonomer C3) selected from compounds of the general formulae (I.a) and (I.b), as defined above.

In the formulae I.a) and I.b), k is preferably an integer from 1 to 100, more preferably 2 to 50, especially 3 to 30. Preferably, l is an integer from 0 to 50.

Preferably, R² in the formulae I.a) and I.b) is hydrogen, methyl, ethyl, n-propyl, isopropyl, n-butyl, sec-butyl or tert-butyl.

In the formula I.b), x is preferably 1 or 2.

The monomer composition M) may comprise each of the further monomers C1) to C3) preferably in an amount of 0% to 30% by weight, more preferably 0% to 20% by weight and especially 0% to 10% by weight, based on the total weight of the monomer composition M). When the monomer composition M) comprises at least one monomer selected from C1) to C3), it does so in each case preferably in an amount of 0.1% to 30% by weight, more preferably 1% to 20% by weight and especially 1.5% to 10% by weight, based on the total weight of the monomer composition M). In a specific embodiment, the monomer composition M) does not comprise any further comonomers except for the monomers A).

Preferably, the polymer composition P2) obtainable by free-radical polymerization of a monomer composition M) in the presence of at least one (C₈-C₁₈-alkyl)polyoxyalkylene ether PE) comprises essentially uncrosslinked polymers. The monomer composition M) used for production of the polymer composition P2) especially does not comprise any added crosslinking monomers. In the context of the invention, crosslinking monomers are compounds having two or more than two polymerizable ethylenically unsaturated double bonds per molecule.

Specifically, the monomer composition M), based on the total weight, comprises less than 0.1% by weight, more specifically less than 0.01% by weight of crosslinking monomers having two or more than two free-radically polymerizable α,β-ethylenically unsaturated double bonds per molecule.

In a preferred embodiment, the monomer composition M) does not comprise any crosslinking monomers having two or more than two polymerizable α,β-ethylenically unsaturated double bonds per molecule.

C₈-C₁₈-Alkyl Polyoxyalkylene Ether PE)

Suitable C₈-C₁₈-alkyl polyoxyalkylene ethers generally have a number-average molecular weight in the range from 260 to 1000 g/mol and preferably 300 to 800 g/mol.

The C₈-C₁₈-alkyl radicals of the C₈-C₁₈-alkyl polyoxyalkylene ethers (PE) are preferably C₁₂-C₁₈-alkyl radicals, for example C₉-C₁₆-alkyl radicals or C₁₀-C₁₄-alkyl radicals.

Suitable C₈-C₁₈-alkyl polyoxyalkylene ethers are those which derive from a single alcohol having 12 to 18 carbon atoms, for example having 9 to 16 carbon atoms or having 10 to 14 carbon atoms. These include, for example, coconut alcohol, palm alcohol, tallow alcohol or oleyl alcohol.

Suitable C₈-C₁₈-alkyl polyoxyalkylene ethers are also those which derive from alcohol mixtures, for example selected from C₁₂C₁₄ alcohols, C₉C₁₁ alcohols, C₁₃C₁₅ alcohols, C₁₂C₁₈ alcohols and C₁₂C₁₄ alcohols.

The C₈-C₁₈-alkyl polyoxyalkylene ethers comprise, in the polyoxyalkylene ether group, preferably an average of 3 to 10 and more preferably 5 to 9 alkylene oxide units per mole of alcohol.

Suitable alkylene oxides for preparation of the C₈-C₁₈-alkyl polyoxyalkylene ethers are, for example, ethylene oxide, propylene oxide, epichlorohydrin, 1,2- and 2,3-butylene oxide.

The stated alkoxylation levels, specifically ethoxylation levels, are statistical averages (number averages, M_{N}) which may be an integer or a fraction for a specific product. Suitable polyoxyalkylene ether groups are, for example, homopolymers of ethylene oxide, homopolymers of propylene oxide, copolymers of ethylene oxide and propylene oxide, copolymers of ethylene oxide and butylene oxide, and copolymers of ethylene oxide, propylene oxide and at least one butylene oxide. The polyoxyalkylene ether groups comprising various copolymerized alkylene oxides may comprise the alkylene oxide units in random distribution or in the form of blocks. A specific embodiment is that of polyoxyalkylene ether groups comprising copolymerized ethylene oxide and propylene oxide. Preferably, in the ethylene oxide/propylene oxide copolymers, the proportion of ethylene oxide-derived repeat units is 40% to 99% by weight. Particular preference is given to C₈-C₁₈-alkyl polyoxyalkylene ethers wherein the polyoxyalkylene ether group comprises exclusively repeat ethylene oxide units.

The polyether groups of the C₈-C₁₈-alkyl polyoxyalkylene ethers PE) may, at the non-C₈-C₁₈-alkyl-terminated ends, bear a hydrogen atom or be terminated by a C₁-C₄-alkyl group.

C₈-C₁₈-alkyl polyoxyalkylene ethers PE) used are preferably alkoxylated, advantageously ethoxylated, especially primary alcohols having preferably 8 to 18 carbon atoms and an average of 3 to 12, preferably 3 to 10 and more preferably 5 to 9 mol of ethylene oxide (EO) per mole of alcohol, in which the alcohol radical may be linear or preferably 2-methyl-branched or may comprise linear and methyl-branched radicals in a mixture, as are typically present in oxo process alcohol radicals.

The C₈-C₁₈-alkyl polyoxyalkylene ethers PE) are preferably selected from:
C₁₂C₁₄ fatty alcohols with 3 EO, 5 EO, 7 EO or 9 EO,
C₉C₁₁ oxo process alcohols with 7 EO,
C₁₃ oxo process alcohol with 3 EO, 5 EO, 7 EO or 9 EO,
C₁₃C₁₅ oxo process alcohols with 3 EO, 5 EO, 7 EO or 9 EO,
C₁₂C₁₈ fatty alcohols with 3 EO, 5 EO, 7 EO or 9 EO and mixtures thereof,
2-propylheptanol with 3 EO, 4 EO, 5 EO, 6 EO, 7 EO, 8 EO and 9 EO,
   and mixtures of two or more than two of the aforementioned ethoxylated alcohols.

Polymer compositions P2) obtainable by free-radical polymerization of a monomer composition M) which comprises at least one α,β-ethylenically unsaturated carboxylic acid in the presence of at least one (C₅-C₁₈-alkyl)polyoxyalkylene ether PE) are known and described in WO 2018/109201. The process for the preparation of such a polymer composition P2) is described in WO 2017/158002, page 18, line 26 to page 26, line 10 which is incorporated herein by reference. The polymer compositions P2) obtained in this way are advantageously suitable for the production of washing- and cleaning-active polymer films, for example for use as a washing or cleaning composition or as a sheath for a liquid washing or cleaning composition.

The weight-average molecular weight M_{W} of the polymer composition P2) obtainable by free-radical polymerization of a monomer composition M) which comprises at least one α,β-ethylenically unsaturated carboxylic acid in the presence of at least one (C₈-C₁₈-alkyl)polyoxyalkylene ether PE) can be determined by means of gel permeation chromatography (GPC) in aqueous solution using neutralized polyacrylic acid as polymer standard. This type of molecular weight determination covers the components of the polymer composition which comprise the monomers M) in copolymerized form. The polymer composition P2) preferably has a weight-average molecular weight of 2000 to 100 000 g/mol, preferably of 3000 to 80 000 g/mol.

In a further embodiment, the polymer composition provided in step a) comprises a polymer component P2) selected from natural and modified polysaccharides.

Polysaccharides suitable as polymers P2) are natural polysaccharides, for example cellulose, hemicellulose, glycogen, starch (amylose and amylopectin), dextran, pectins, inulin, xanthan, chitin, callose, etc. and thermally, hydrolytically or enzymatically degraded natural polysaccharides, for example maltodextrin etc.

Preferred modified polysaccharides are, for example, cellulose ethers, cellulose esters, cellulose amides, etc.

Cellulose ethers are derivatives of cellulose which arise through partial or complete substitution of the hydrogen atoms in the hydroxyl groups of the cellulose. Cellulose ethers from the reaction of cellulose with more than one etherifying agent are also referred to as cellulose mixed ethers.

Preferred cellulose ethers are selected from alkyl celluloses, hydroxyalkyl celluloses, hydroxyalkyl alkyl celluloses, carboxyalkyl celluloses and salts thereof, carboxyalkyl alkyl celluloses and salts thereof, carboxyalkyl hydroxyalkyl celluloses and salts thereof, carboxyalkyl hydroxyalkyl alkyl celluloses and salts, sulfoalkyl celluloses and salts thereof.

Preferred carboxyalkyl radicals are the carboxymethyl radical and the carboxyethyl radical. A particularly preferred carboxyalkyl radical is the carboxymethyl radical. Preferred sulfoalkyl radicals are the sulfomethyl radical and the sulfoethyl radical. A particularly preferred sulfoalkyl radical is the sulfomethyl radical. Preferred salts are the sodium, potassium, calcium and ammonium salts.

Particularly preferred cellulose ethers are selected from carboxymethyl cellulose, carboxyethyl cellulose, methyl cellulose, ethyl cellulose, n-propyl cellulose, ethyl methyl cellulose, hydroxyethyl cellulose, hydroxypropyl cellulose, hydroxybutyl cellulose, hydroxyethyl methyl cellulose, hydroxypropyl methyl cellulose, hydroxyethyl ethyl cellulose, hydroxypropyl ethyl cellulose, carboxymethyl methyl cellulose, carboxymethyl ethyl cellulose, carboxymethyl hydroxyethyl cellulose, carboxymethyl hydroxyethyl methyl cellulose, carboxymethyl hydroxyethyl ethyl cellulose, sulfomethyl cellulose and sulfoethyl cellulose. The carboxyalkyl radicals and the sulfoalkyl radicals may also be in salt form.

Cellulose esters are derivatives of cellulose which form as a result of esterification of the hydroxyl groups with acids. Preference is given to the sulfuric esters of cellulose. In a specific embodiment, the sulfuric acid is subjected only to a partial esterification, such that the resulting sulfuric esters still have free acid groups or salts thereof. Particular preference is given to using acidic sulfuric ester salts of cellulose. These are notable for their graying-inhibiting effect.

Preferred modified polysaccharides are selected from methyl cellulose, ethyl cellulose, propyl cellulose, methyl/ethyl cellulose, ethyl/propyl cellulose, carboxymethyl cellulose, salts of carboxymethyl cellulose, hydroxyethyl cellulose, hydroxypropyl cellulose, hydroxyethyl methyl cellulose, hydroxyethyl ethyl cellulose, hydroxypropyl methyl cellulose, hydroxypropyl ethyl cellulose, etc.

In a further preferred embodiment, the polymers P2) are selected from homo- and copolymers comprising repeat units which derive from vinyl alcohol, vinyl esters, alkoxylated vinyl alcohols or mixtures thereof.

Suitable vinyl esters (vinyl acylates) are generally the esters of vinyl alcohol with C₁-C₁₅ carboxylic acids, preferably C₁-C₈ carboxylic acids, more preferably C₁-C₄ carboxylic acids. Preferred vinyl acylates are vinyl acetate, vinyl n-propionate, vinyl n-butyrate, vinyl 2-ethylhexanoate, vinyl laurate, etc. Particular preference is given to vinyl acetate.

Partly or fully hydrolyzed polyvinyl acetates (PVAs) are generally referred to as “polyvinyl alcohol (PVOH)”. Partly hydrolyzed polyvinyl acetates are obtained by incomplete hydrolysis of polyvinyl acetates, meaning that the partly hydrolyzed polymer has both ester groups and hydroxyl groups. The hydrolysis of the polyvinyl acetates can be effected in a manner known per se under alkaline or acidic conditions, i.e. with addition of acid or base.

The performance properties of polyvinyl alcohols are determined by factors including the polymerization level and the hydrolysis level (level of hydrolysis). With rising hydrolysis level, the water solubility decreases. Polyvinyl alcohols having hydrolysis levels up to about 90 mol % are generally soluble in cold water. Polyvinyl alcohols having hydrolysis levels of about 90 to about 99.9 mol % are generally no longer soluble in cold water but are soluble in hot water.

Polyvinyl alcohols suitable as polymers P2) preferably have a hydrolysis level of 50 to 99.9 mol %, more preferably of 70 to 99 mol %, especially of 80 to 98 mol %.

Polyvinyl alcohols suitable as polymers P2) preferably have a weight-average molecular weight of 10 000 to 300 000 g/mol, more preferably of 15 000 to 250 000 g/mol.

Polyvinyl alcohols suitable as polymers P2) preferably have a viscosity of 2 to 120 mPa s, more preferably of 7 to 70 mPa s and especially of 15 to 60 mPa s, measured to DIN 53015 on a 4% solution in water.

Polyvinylalcohol that can typically be used as polymers P2) are known under the tradename Poval™ from Kuraray company. Non limiting examples are Poval™ 8-88, Poval™ 18-88, Poval™ 26-88, Poval™ 30-92, Poval™10-98, Poval™ 20-98 or Poval™ 28-99.

A special embodiment of the polymers P2) are copolymers comprising polyvinylalcohol repeat units and repeat units of at least one anionically modified monomer. Suitable classes of anionically modified monomers comprise monocarboxylic acid vinyl monomers, their esters and anhydrides, dicarboxylic monomers having a polymerizable double bond, their esters and anhydrides, vinyl sulfonic acid monomers, and alkali metal salts of any of the foregoing. Examples of suitable anionically modified monomers are vinyl acetic acid, maleic acid, monoalkyl maleate, dialkyl maleate, monomethyl maleate, dimethyl maleate, maleic anhydride, fumaric acid, monoalkyl fumarate, dialkyl fumarate, (in particular monomethyl fumarate and dimethyl fumarate), fumaric anhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sufoethyl acrylate, alkali metal salts of the foregoing (e.g., sodium, potassium, or other alkali metal salts), esters of the foregoing (e.g., methyl, ethyl, or other C₁-C₆ alkyl esters), and combinations thereof (e.g., multiple types of anionic monomers or equivalent forms of the same anionic monomer). In a preferred embodiment, the anionically modified monomer is selected from 2-acrylamido-1-methylpropanesulfonic acid, 2-acrylamido-2-methylpropanesulfonic acid, 2-methylacrylamido-2-methylpropanesulfonic acid, itaconic acid, monomethyl itaconate, dimethyl itaconate, itaconic anhydride and the alkali metal salts thereof. The level of incorporation of the one or more anionically modified monomer units in the PVOH copolymers is not particularly limited. In a suitable embodiment, the one or more anionically modified monomer units are present in the PVOH copolymer in an amount in a range of about 2 mol % to about 10 mol %.

To tune the performance properties according to the specific need of the application blends comprising polyvinylalcohols of different molecular weight and degree of hydrolysis can be used. Suitable blends are selected from a blend of at least two different polyvinylalcohol homopolymers, a blend of at least two different polyvinylalcohol copolymers, a blend of at least one polyvinylalcohol homopolymer and at least one polyvinylalcohol copolymer. Suitable polyvinylalcohol copolymers for the blends are those mentioned above.

Non limiting examples of blends of polyvinylalcohol homopolymers are a blend of Poval™ 26-88 (three parts) and Poval™ 20-98 (one part) or a blend of Poval™ 30-92 (two parts) and Poval™ 10-98 (one part).

In a further preferred embodiment, the polymers P2) are selected from homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof.

N-Vinylimidazole, 2-vinylpyridine and 4-vinylpyridine can be converted to the corresponding salts by protonation or quaternization. Suitable acids are, for example, mineral acids such as sulfuric acid, hydrochloric acid and phosphoric acid, and carboxylic acids. Alkylating agents suitable for quaternization are C₁-C₄-alkyl halides or C₁-C₄-alkyl sulfates, such as ethyl chloride, ethyl bromide, methyl chloride, methyl bromide, dimethyl sulfate and diethyl sulfate.

Preference is given to polyvinylpyrrolidone homopolymers and copolymers comprising copolymerized N-vinylpyrrolidone and another different copolymerized ethylenically unsaturated monomer. Suitable N-vinylpyrrolidone copolymers are quite generally uncharged, anionic, cationic and amphoteric polymers.

Particularly preferred N-vinylpyrrolidone copolymers are selected from

copolymers of N-vinylpyrrolidone and vinyl acetate,
copolymers of N-vinylpyrrolidone and vinyl propionate,
copolymers of N-vinylpyrrolidone, vinyl acetate and vinyl propionate,
copolymers of N-vinylpyrrolidone and vinyl acrylate,
copolymers of N-vinylpyrrolidone, ethyl methacrylate and methacrylic acid,
copolymers of N-vinylpyrrolidone and N-vinylimidazole and the derivatives thereof obtained by protonation and/or quaternization,
copolymers of N-vinylpyrrolidone and dimethylaminoethyl methacrylate and the derivatives thereof obtained by protonation and/or quaternization,
copolymers of N-vinylpyrrolidone, N-vinylcaprolactam and N-vinylimidazole and the derivatives thereof obtained by protonation and/or quaternization.

In a further preferred embodiment, the polymers P2) are selected from homo- and copolymers of acrylic acid and/or methacrylic acid.

In a first specific embodiment of the homo- and copolymers of acrylic acid and/or methacrylic acid, the polymer P2) used is an acrylic acid homopolymer. Acrylic acid homopolymers P2) preferably have a number-average molecular weight in the range from 800 to 70 000 g/mol, more preferably 900 to 50 000 g/mol, particularly 1000 to 20 000 g/mol and especially 1000 to 10 000 g/mol. In this context, the term “acrylic acid homopolymer” also encompasses polymers in which the carboxylic acid groups are in partly or fully neutralized form. These include acrylic acid homopolymers in which the carboxylic acid groups are present partly or completely in the form of alkali metal salts or ammonium salts. Preference is given to acrylic acid homopolymers in which the carboxylic acid groups are protonated or are partly or completely in the form of sodium salts. Homopolymers of acrylic acid particularly suitable as polymers P2) are the Sokalan® PA brands from BASF SE.

In a second specific embodiment of the homo- and copolymers of acrylic acid and/or methacrylic acid, polymer P2) used is a copolymer comprising at least one copolymerized acrylic acid monomer selected from acrylic acid, acrylic salts and mixtures thereof and at least one copolymerized maleic monomer selected from maleic acid, maleic anhydride, maleic salts and mixtures thereof. These preferably have a number-average molecular weight in the range from 2500 to 150 000 g/mol, more preferably 2800 to 70 000 g/mol, particularly 2900 to 50 000 g/mol and especially 3000 to 30 000 g/mol. Also included here are copolymers in which the carboxylic acid groups are in partly or fully neutralized form. For this purpose, it is either possible to use monomers in salt form for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

Preferred polymers P2) are copolymers of maleic acid (or maleic monomers) and acrylic acid (or acrylic monomers) in a weight ratio of 10:90 to 95:5, more preferably those in a weight ratio of 30:70 to 90:10.

Preferred polymers P2) are also terpolymers of maleic acid (or maleic monomers), acrylic acid (or acrylic monomers) and a vinyl ester of a C₁-C₃ carboxylic acid in a weight ratio of 10 (maleic acid):90 (acrylic acid+vinyl ester) to 95 (maleic acid):10 (acrylic acid+vinyl ester). The weight ratio of acrylic acid to vinyl ester is preferably within a range from 30:70 to 70:30.

Particularly suitable polymers P2) based on acrylic monomers and maleic monomers are the corresponding Sokalan® CP brands from BASF SE.

In a third specific embodiment of the homo- and copolymers of acrylic acid and/or methacrylic acid, polymer P2) used is a copolymer comprising at least one (meth)acrylic acid monomer selected from (meth)acrylic acid, (meth)acrylic salts and mixtures thereof and at least one hydrophobic monomer. The hydrophobic monomer is especially selected from C₁-C₈-alkyl esters of (meth)acrylic acid, for example the methyl, ethyl, n- and isopropyl, n-butyl and 2-ethylhexyl esters of (meth)acrylic acid and C₂-C₁₀ olefins, for example ethene, propene, 1,2-butene, isobutene, diisobutene, styrene and α-methylstyrene.

In a further preferred embodiment, the polymer P2) used is a copolymer of at least one maleic monomer selected from maleic acid, maleic anhydride, maleic salts and mixtures thereof with at least one C₂-C₈ olefin. Also suitable are copolymers comprising at least one copolymerized maleic monomer selected from maleic acid, maleic anhydride, maleic salts and mixtures thereof, at least one copolymerized C₂-C₈ olefin and at least one other different copolymerized comonomer.

Particular preference is given to copolymers comprising at least one copolymerized maleic monomer selected from maleic acid, maleic anhydride, maleic salts and mixtures thereof and at least one copolymerized C₂-C₈ olefin as the sole monomers. These preferably have a number-average molecular weight in the range from 3000 to 150 000 g/mol, more preferably 5000 to 70 000 g/mol, particularly 8000 to 50 000 g/mol and especially 10 000 to 30 000 g/mol. Also included here are copolymers in which the carboxylic acid groups are in partly or fully neutralized form. For this purpose, it is either possible to use maleic salts for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

A specific embodiment is copolymers of maleic acid with C₂-C₈ olefins in a molar ratio of 40:60 to 80:20, particular preference being given to copolymers of maleic acid with ethylene, propylene, isobutene, diisobutene, isoprenol or styrene. Particularly suitable compounds which contain carboxylic acid groups and are based on olefins and maleic acid are likewise the corresponding Sokalan® CP brands from BASF SE.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized acrylic monomer selected from acrylic acid, acrylic salts and mixtures thereof.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized ester of (meth)acrylic acid. In that case, the ester of (meth)acrylic acid is especially selected from C₁-C₈-alkyl esters of (meth)acrylic acid, for example the methyl, ethyl, n- and isopropyl, n-butyl and 2-ethylhexyl esters of (meth)acrylic acid.

In a further preferred embodiment, the polymers P2) are selected from homo- and copolymers comprising at least one monomer comprising sulfonic acid groups.

Preferred monomers comprising sulfonic acid groups are selected from 1-acrylamido-1-propanesulfonic acid, 2-acrylamido-2-propanesulfonic acid, 2-acrylamido-2-methylpropanesulfonic acid (AMPS), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and the salts of said acids. Suitable salts are generally water-soluble salts, preferably the sodium, potassium and ammonium salts of said acids.

Particular preference is given to 1-acrylamidopropanesulfonic acid, 2-acrylamido-2-propanesulfonic acid, 2-acrylamido-2-methylpropanesulfonic acid (AMPS), 2-methacrylamido-2-methylpropanesulfonic acid, 3-methacrylamido-2-hydroxypropanesulfonic acid, 2-hydroxy-3-(2-propenyloxy)propanesulfonic acid, 2-sulfoethyl methacrylate, styrenesulfonic acid, vinylsulfonic acid, allylsulfonic acid and methallylsulfonic acid, and also salts of said acids.

Very particularly preferred monomers comprising sulfonic acid groups are 2-acrylamido-2-methylpropanesulfonic acid (AMPS) and allylsulfonic acid, and water-soluble salts thereof, in particular sodium, potassium and ammonium salts thereof.

Particular copolymers and terpolymers are:
copolymers of 2-acrylamido-2-methylpropane sulfonic acid and acrylic acid,
copolymers of acrylic acid and allylsulfonic acid,
terpolymers of 2-acrylamido-2-methyl-propane sulfonic acid, acrylic acid and itaconic acid,
terpolymers of isoprenol, maleic acid and 2-acrylamido-2-methylpropane sulfonic acid,
terpolymers of isoprenol, maleic acid and allylsulfonic acid.

In a further preferred embodiment, the polymers P2) are selected from homo- and copolymers comprising at least one copolymerized monomer selected from acrylamide, methacrylamide and mixtures thereof. These polymers P2) are preferably water-soluble or water-dispersible. These polymers P2) are especially water-soluble.

In a specific embodiment, the polymers P2) are selected from homopolymers of acrylamide or methacrylamide.

In a further specific embodiment, the polymers P2) are selected from copolymers of acrylamide and/or methacrylamide. These comprise at least one copolymerized comonomer selected from hydrophilic monomers (A1) other than acrylamide and methacrylamide, monoethylenically unsaturated amphiphilic monomers (A2) and further ethylenically unsaturated monomers (A3).

Suitable hydrophilic monoethylenically unsaturated monomers (A1) are uncharged monomers such as N-methyl(meth)acrylamide, N,N′-dimethyl(meth)acrylamide or N-methylol(meth)acrylamide, monomers comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether, polyethylene glycol (meth)acrylate, N-vinylformamide, N-vinylacetamide, N-vinylpyrrolidone or N-vinylcaprolactam, and vinyl esters, for example vinyl formate or vinyl acetate. After polymerization, N-vinyl derivatives may be hydrolyzed to vinylamine units, and vinyl esters to vinyl alcohol units. Suitable hydrophilic monoethylenically unsaturated monomers (A1) are also monomers comprising at least one acidic group or salts thereof. These include acrylic acid, methacrylic acid, crotonic acid, itaconic acid, maleic acid, fumaric acid, vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, 2-acrylamido-2,4,4-trimethylpentanesulfonic acid, vinylphosphonic acid, allylphosphonic acid, N-(meth)acrylamidealkylphosphonic acids, (meth)acryloyloxyalkylphosphonic acids and salts and mixtures thereof. The further monoethylenically unsaturated hydrophilic monomers may be hydrophilic cationic monomers. Suitable cationic monomers (A1c) especially include monomers having ammonium groups, especially ammonium derivatives of N-(ω-aminoalkyl)(meth)acrylamides or ω-aminoalkyl (meth)acrylates.

The amphiphilic monomers (A2) are monoethylenically unsaturated monomers having at least one hydrophilic group and at least one, preferably terminal, hydrophobic group.

The monomers (A3) may, for example, be monoethylenically unsaturated monomers which have a more hydrophobic character than the hydrophilic monomers (A1) and are accordingly water-soluble only to a minor degree. Examples of such monomers include N-alkyl- and N,N′-dialkyl(meth)acrylamides, where the number of carbon atoms in the alkyl radicals together is at least 3, preferably at least 4. Examples of such monomers include N-butyl(meth)acrylamide, N-cyclohexyl(meth)acrylamide or N-benzyl(meth)acrylamide.

In a further preferred embodiment, the polymers P2) are selected from polyamino acids. Suitable polyamino acids are in principle compounds comprising at least one copolymerized amino acid such as aspartic acid, glutamic acid, lysine, glycine, etc. The polyamino acids also include the derivatives obtainable by polymer-analogous reaction, such as esterification, amidation, etc. Preferred polyamino acids are polyaspartic acid, polyaspartic acid derivatives, polyglutamic acid, polyglutamic acid derivatives and mixtures thereof.

Polyaspartic acid can be prepared, for example, by alkaline hydrolysis of polysuccinimide (PSI, anhydropolyaspartic acid). Polysuccinimide can be prepared by thermal condensation of aspartic acid or from ammonia and maleic acid. Polyaspartic acid can be used, for example, as a biodegradable complexing agent and cobuilder in washing and cleaning compositions.

Polyamino acids having surfactant properties can be obtained by at least partly converting the free carboxylic acid groups of polyaspartic acid or polyglutamic acid to N-alkylamides and/or to esters. Polyaspartamides can also be prepared by reaction of polysuccinimide with amines. For preparation of hydroxylethylaspartamides, the ring opening of polysuccinimide can be conducted with ethanolamine. DE 37 00 128 A and EP 0 458 079 A describe the subsequent esterification of such hydroxyethyl derivatives with carboxylic acid derivatives. Copolymeric polyaspartic esters are obtainable as described in DE 195 45 678 A by condensation of monoalkyl esters of maleic or fumaric acid with addition of ammonia. DE 195 45 678 A further states that copolymeric polyaspartic esters are obtainable by reaction of polysuccinimide with alcohols, optionally followed by hydrolysis. According to the esterification level and hydrophobicity of the alcohol component, polyaspartic esters, aside from their biodegradability, are notable for excellent properties as stabilizers for O/W and W/O emulsions, as a foam-stabilizing and foam-boosting cosurfactant in washing and cleaning compositions, and as a complexing agent for metal cations.

In a further preferred embodiment, the polymers P2) are selected from polyalkylene glycols and mono- or diethers of polyalkylene glycols different from P1). Preferred polyalkylene glycols have a number—average molecular weight in the range from 1000 to 4 000 000 g/mol, more preferably from 1500 to 1 000 000 g/mol.

Suitable polyalkylene glycols and the mono- and diethers thereof may be linear or branched, preferably linear. Suitable polyalkylene glycols are, for example, water-soluble or water-dispersible nonionic polymers having repeat alkylene oxide units. Preferably, the proportion of repeat alkylene oxide units is at least 30% by weight, preferably at least 50% by weight and especially at least 75% by weight, based on the total weight of the compound. Suitable polyalkylene glycols are polypropylene glycols, poly-tetrahydrofurans and copolymers comprising in polymerized form at least two alkylene oxides selected from propylene oxide, epichlorohydrin, 1,2- and 2,3-butylene oxide. The alkylene oxide copolymers may comprise the copolymerized alkylene oxide units in randomly distributed form or in the form of blocks.

Suitable mono- and diethers of polyalkylene glycols are the mono-(C₁-C₁₈-alkyl ethers) and di-(C₁-C₁₈-alkyl ethers). Preferred mono- and diethers of polyalkylene glycols are the mono-(C₁-C₆-alkyl ethers) and di-(C₁-C₆-alkyl ethers). Especially preferred are the mono-(C₁-C₂-alkyl ethers) and di-(C₁-C₂-alkyl ethers). Especially preferred are polyalkylene glycol monomethyl ethers and polyalkylene glycol dimethyl ethers.

Preferably, the weight ratio of the polymer composition P1) to the polymer composition P2) is in a range from 99.99:0.01 to 1.0:99.0, more preferably 99.9:0.1 to 10:90, in particular 99.5:0.5 to 20:80.

It is possible to add at least one additive to the polymer composition prior to calendering in step b). Suitable for additivation are the afore-mentioned polymer compositions P2) and all further additives, mentioned in detail in the following for the washing, cleaning and dishwashing compositions.

The additive is preferably selected from nonionic, anionic, cationic and amphoteric surfactants, polymeric dispersants, builders, complexing agents, bleaches, bleach activators, bleach catalysts, enzymes, enzyme stabilizers, bases, corrosion inhibitors, defoamers and foam inhibitors, wetting agents, dyes, pigments, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, antistats, ironing aids, hydrophobizing and impregnating agents, antiswell and antislip agents, plasticizers, scavengers, polymers other than the polymer component P1) and the polymers P2), agents for modification of gas permeability and water vapor permeability, glidants, slip agents and UV absorbers and mixtures thereof.

### Calenderering (Step b)

In step b) of the process according to the invention, the polymer composition in powder form provided in step a) is fed into a calender and subjected to a film formation. It is a critical feature that the film is formed by a solid-state film formation process that takes place at a low temperature.

In principle, in the process of the invention well-known and commercially available calenders can be employed. Thus, it is possible to employ calenders comprising 2, 3, 4 or more than 4 calender rolls. In the simplest preferred embodiment, the calender used in the process of the invention is a 2 roll calender. The polymer composition can be passed through the calender once or repeatly, e.g. 1, 2, 3, 4, 5 or more than 5 times. If the polymer composition is passed repeatedly through the calender the condition of each pass can be the same on each pass or can vary from pass to pass.

The calender rolls can be arranged in a geometry suitable for calendering a solid, in particular powdery, polymer composition feed. A two-roll calender can have a vertical, inclined or horizontal arrangement of the rolls. A three-roll calender can be in a vertical (1-type), off-set top roll or off-set bottom roll arrangement. A four-roll calender can have an L-type, inverted L-type, S-type, Z-type or other arrangement of the rolls. As mentioned in the following, there are preferred arrangements depending on the way the polymer composition in powder form is fed to the calender. In particular, the arrangement can be adjusted depending respectively on whether the polymer composition in powder form is fed without or with a support to the calender.

Each pair of calender rolls with opposite rotation in direction of the rotary axes forms a nip through which the polymer composition is passed. In other words, in each nip the direction of movement tangential to the surfaces of the calender rolls is the same. Preferably, in each nip the surfaces of the calender rolls move with the same velocity. The polymer composition in powder form is supplied to the first nip in the direction of motion through the calender. In a calender with three or more rolls, the first nip is also denoted as feed nip. The polymer composition can be fed to the calender on a substrate (carrier material) or without the help of a substrate. If the polymer is fed to the calender without the help of a substrate it is preferably metered into the first nip in form of a free-falling material.

In a first embodiment, the polymer composition is fed to the calender supported on a substrate and in case of a two roll calender the calender rolls are preferably in a vertical or in an inclined arrangement, in particular in a vertical arrangement. In other words, the polymer composition on the support passes in horizontal direction through the pair of calender rolls. In case of a calender with 3, 4 or more rolls, the first two calender rolls are preferably in a vertical or in an inclined arrangement, in particular in a vertical arrangement. The substrate used as support for the polymer composition in powder form moves continuously through the calender. After calendering, the support can be separated from the polymer composition. It is possible to subject the obtained polymer composition to one or more further calendering steps without the support material. In a suitable embodiment, the support material is in form of an endless tape that acts like a kind of conveyor belt for the polymer composition.

Suitable support materials are firstly selected from known flexible supports having sufficient mechanical strength and which enable simple detachment of the polymer film from the support material. Preferably, the support material is selected from polymer materials having a higher melting point than the polymer composition in powder form being fed to the calender. Preferably, the support material is selected from heat-resistant polymers that allow a separation of the polymer composition from the support material after calendering. Suitable support materials are selected from steel, polymers such as polycarbonates, polyethylene terephthalate, silicones, polyamides or polyurethanes, polymer-coated paper, such as silicone paper, etc.

Suitable devices for dosing the polymer composition in powder form from a reservoir to the support material are in principle known. The dosing device can be placed directly above the support material. Then the polymer composition in powder form can be directly metered to the support, e.g. by a check valve. It is possible, that the reservoir and the dosing device are integrated in a single device. It is also possible to transport the polymer composition in powder form from the reservoir to the dosing device and/or from the dosing device to the support. Suitable means for transporting the polymer composition in powder form are e.g. screw conveyors, conveyor belts, etc. It is also possible to feed the polymer composition from the reservoir to the support material and to meter the polymer composition then with a coating knife with adjustable gap.

In a second embodiment, the polymer composition is fed to the calender without the use of a supporting substrate. According to this embodiment, in case of a two roll calender the calender rolls are preferably in a horizontal or in an inclined arrangement, in particular in a horizontal arrangement. In case of a calender with 3, 4 or more rolls, the first two calender rolls are preferably in a horizontal or in an inclined arrangement, in particular in a horizontal arrangement.

Preferably, in this embodiment the polymer composition in powder form is metered directly in the first nip of the calender. Suitable devices for the dosage of the polymer composition in powder form from a reservoir to the first nip are in principle known. In principle, it is possible to use the same devices mentioned for the dosage of the polymer composition in powder form from a reservoir to the support material according to the first embodiment.

The calendering in step b) is preferably effected at a temperature of at least 5° C., more preferably of at least 10° C., below the melting point of the ethylene oxide homo- or copolymer P1).

The calendering in step b) is preferably effected at a temperature in the range from 10 to 80° C., more preferably from 15 to 70° C., especially from 20 to 60° C., in particular from 20 to 45° C.

The different rolls of the calender can all have the same temperature or two or more than two of the rolls can have different temperatures.

The polymer composition can be passed through the calender in a single pass or repeatedly. If the polymer composition is passed repeatedly through the calender, the temperature of each roll in the subsequent step is preferably the same as in the previous step.

The calendering in step b) is preferably effected by exerting a linear force in the range of 50 to 5000 N/mm, preferably 100 to 2500 N/mm.

If the calendering in step b) is effected in a calender comprising 3, 4 or more than 4 rolls, then the linear force applied in each calender nip is in the range of 50 to 5000 N/mm, preferably 100 to 2500 N/mm.

If the calendering in step b) is effected in a calender comprising 3, 4 or more than 4 rolls, then the linear force applied in the second and each subsequent calender nip is higher than or equal to the linear force applied in the first calender nip.

In a preferred embodiment, the polymer composition is passed repeatedly through a two roll calender. Then the linear force applied in the second and each subsequent pass is higher than or equal to the linear force applied in the first pass. Preferably, the linear force applied in the first pass is in the range of 250 to 1250 N/mm, preferably 500 to 1000 N/mm. Preferably, the linear force applied in the second pass (and if applicable each subsequent pass) is in the range of 1000 to 2500 N/mm, preferably 1250 to 2000 N/mm.

Preferably the calendering in step b) is effected at a speed of 0.05 m/min to 1000 m/min.

Preferably, the polymer film exiting the calender is being rolled up by a rewinder roll. Preferably, the web tension is controlled by the torque of the rewinder in the range of from 10 N/m to 1000 N/m, preferably from 100 N/m to 500 N/m.

After leaving the calender, the polymer film can be subjected to further processing steps. Thus e.g. the film can be further stretched along one axis or two orthogonal axes. Suitable longitudinal and laterally drawing units are known to the person skilled in the art.

The process of the invention allows the production of polymer films with a broad thickness range. Preferably, the thickness of the films obtained by the process according to the invention is in a range of 0.5 μm to 20 mm, more preferably 1 μm to 10 mm, in particular 5 μm to 500 μm.

To produce film portions, the film material can be confectioned in a suitable manner, e.g. by cutting into a suitable size and/or folding to form compartments. Then the edges can be sealed by customary sealing processes, such as hot sealing, liquid sealing or pressure sealing.

A special embodiment is a polymer film that comprises at least one additive. In a special embodiment, the additive is a constituent customary for washing and cleaning and dishwashing compositions. Suitable additives are the afore-mentioned polymer compositions P2) and all further additives, mentioned in detail in the following for the washing, cleaning and dishwashing compositions.

Suitable complexing agents are methylglycinediacetic acid, glutaminediacetic acid, glutamic acid, diacetic acid and citric acid and the sodium and potassium salts thereof.

In a preferred embodiment, the polymer film of the invention comprises, as additive, at least one enzyme and optionally at least one enzyme stabilizer. Suitable enzymes and enzymes stabilizers are those mentioned in the following as component E1) of the detergent and cleaner formulations.

Suitable bitter substances are those mentioned in the following as component E6) of the detergent and cleaner formulations.

In a specific embodiment, the polymer film comprises a polyvinylpyrrolidone homo- or co-polymer or a polyvinylalcohol polymer and at least one enzyme as additive. In particular, the polymer film comprises a polyvinylalcohol polymer and at least one enzyme as additive.

In order to make the polymer films more flexible, plasticizers can be added to them before or during production. For the production of a polymer composition capable of film formation, preferably 0.5% to 30% by weight, more preferably 2% to 20% by weight and especially 3% to 15% by weight of plasticizer is used, based on the total weight of the composition.

Suitable plasticizers are alkyleneamines, alkanolamines, polyols, such as alkylene glycols and oligoalkylene glycols, e.g. 2-methyl-1,3-propanediol, 3-methyl-1,5-pentadiol, hydroxypropylglycerol, neopentyl glycol, alkoxylated glycerol (such as e.g. Voranol® from Dow Chemicals), water-soluble polyesterpolyols (such as e.g. TriRez from Geo Specialty Chemicals) and mixtures thereof. Suitable plasticizers are also polyetherpolyols, which are available under the name Lupranol® from BASF SE. The term “alkyleneamines” refers to condensation products of alkanolamines with ammonia or primary amines, e.g. ethyleneamines are obtained by reaction of monoethanolamine with ammonia in the presence of a catalyst. Here, the following result as main components: ethylenediamine, piperazine, diethylenetriamine and aminoethylethanolamine.

Preferably, the plasticizers are selected from glycerol, diglycerol, propylene glycols with a weight-average molecular weight of up to 400, dipropylene glycol, ethylene glycol, diethylene glycol, triethylene glycol, tetraethylene glycol, sorbitol, isopentyldiol, polyethylene glycol, trimethylolpropane, diethylenetriamine, triethylenepentamine, triethanolamine and mixtures thereof.

In order to make the polymer films according to the invention more resistant to aggressive ingredients (such as e.g. chlorine-releasing compounds, as are used in the area of disinfection of water, etc.), so-called “scavengers” (capture molecules) can be added to the film. Suitable scavengers are polyamines, polymeric polyamines, such as polyethyleneimines, poly(amidoamines) and polyamides. Moreover, it is also possible to use ammonium sulfate, primary and secondary amines with a low vapor pressure, such as ethanolamines, amino acid and salts thereof, and also polyamino acid and salts thereof, fatty amines, glucosamines and other aminated sugars. Furthermore, reducing agents, such as sulfites, bisulfites, thiosulfites, thiosulfates, iodides, nitrites and antioxidants such as carbamates, ascorbates and mixtures thereof can be used.

For production of the polymer films, it is possible to add further additives in the form of polymers to the polymer composition in powder form comprising or consisting of an ethylene oxide homo- or copolymer P1) and/or to the polymers P2) before and/or during the film production. Typically, 0.05 to 20% by weight, preferably 0.1 to 15% by weight, particularly preferably 0.2 to 10% by weight, of polymers (based on the total weight of the polymer compounds, i.e. polymer compositions P1), P2) and additional polymers) are used. Such additives can simultaneously improve the washing properties of the film, improve the mechanical properties of the film, and increase the resistance of the film to detergent components. Suitable polymers are e.g. oligosaccharides and polysaccharides, starch, degraded starches (maltodextrins), cellulose ethers, specifically hydroxyethylcellulose, hydroxypropylcellulose, methylcellulose, ethylcellulose, hydroxypropylmethylcellulose, hydroxypropylethylcellulose, microcrystalline cellulose, inulin, carboxymethylcellulose, e.g. in the form of the sodium salts, alginic acid and alginates, pectin acid and pectins, polyethyleneimines, alkoxylated, in particular ethoxylated polyethyleneimines, graft polymers of vinyl acetate on polyalkylene glycols, in particular on polyethylene glycols, homopolymers of N-vinylpyrrolidone, copolymers of N-vinylpyrrolidone and N-vinylimidazole, copolymers of N-vinylpyrrolidone with vinyl acetate and with vinylcaprolactam, polyalkylene oxides, polyvinyl alcohol, polyvinyl alcohols with fractions of nonhydrolyzed vinyl acetate, thickeners, such as, for example, xanthan gum, guar gum, gelatin, agar-agar and mixtures thereof.

It is additionally possible to subject at least one surface or both surfaces of the polymer films of the invention to at least partial coating with at least one additive. Such a treatment may serve, for example, to provide the surface with particular properties, such as nonstick action, antistatic action, hydrophilic or hydrophobic properties, etc. It is thus possible to provide polymer films, for example, with better detachment properties from the carrier material used in the production, better roll-off properties, better glide properties, reduced tack, better compatibility with particular components ensheathed or coated therewith, etc. According to the nature and formulation of the additive, the application can be effected by standard methods, for example by spraying, dipping, powder application, etc. Suitable additives for coating of the surface of the multilayer films of the invention are, for example, talc, surfactants such as silicone-containing surfactants, waxes, etc.

The film production process is not subject to any particular restrictions and the person skilled in the art is able to apply any desired production process of which he is aware on account of his art knowledge. The same applies to the production of single and multilayer films which are to be used as such for use as a washing composition or as a cleaning composition. The same applies to the production of sheaths and coatings based on a single or multilayer film of the invention.

### Characterization of the Polymer Films

Preferably, the single layer films of the invention have a total weight of all the components P1) and, if present, P2) in the range from 0.1 to 100 mg/cm² of film, more preferably of 1 to 80 mg/cm² of film.

Preferably, the multilayer films of the invention have a total weight of all the components P1) and, if present, P2) in each layer in the range from 0.1 to 100 mg/cm² of film, more preferably of 1 to 80 mg/cm² of film.

The layer thickness of the single layer and multilayer films is variable within wide ranges and is dependent on the field of use of the films.

Preferably, the single layer films for ensheathing or coating a washing or cleaning composition have a layer thickness per layer in the range from 0.5 to 500 μm, preferably from 1 to 250 μm.

Preferably, the multilayer films for ensheathing or coating a washing or cleaning composition have a layer thickness per layer in the range from 0.5 to 500 μm, preferably from 1 to 250 μm.

Preferably, two-layer films for ensheathing or coating a washing or cleaning composition have a total layer thickness in the range from 1 to 1000 μm, preferably from 2 to 750 μm.

Preferably, three-layer films for ensheathing or coating a washing or cleaning composition have a total layer thickness in the range from 1.5 to 1500 μm, preferably from 2 to 1250 μm.

The single layer and multilayer films feature good mechanical properties. These are shown, for example, in tensile tests on film strips of the polymer films as described in standards EN ISO 527-1 and ASTM D882-12. EN ISO 527-1 (current ISO version February 2012) is a European standard for plastics for determination of the tensile properties, which are ascertained by a tensile test with a tensile tester. For these tests, it is possible to use a standard apparatus, for example a universal tester from Zwick GmbH, model TMTC-FR2.5TN.D09. To achieve homogeneous test conditions, the films can first be subjected to storage for several days in equilibrium with the ambient humidity (35-40% relative humidity at 20-25° C.).

Tensile strength is a material property which states the maximum mechanical tensile stress that the material withstands before breaking/tearing. Preferably, the films of the invention have a tensile strength in the range from 3 to 150 N/mm² (=3 to 150 MPa).

Elongation is a dimensionless parameter which is reported in percent. Preferably, the films of the invention have an elongation of 20% to 1000%.

### Washing, Cleaning and Dishwashing Compositions

The polymer films of the invention are suitable as such for use as a washing composition or as a cleaning composition or as a dishwashing composition. The term “dishwashing composition” here also covers rinse aids. The polymer films according to the invention are advantageously suitable for use for the portionwise packaging of washing, cleaning and dishwashing compositions. They are suitable specifically for producing a covering which comprises solid or liquid or gel-like washing, cleaning or dishwashing compositions or at least one of their components. The polymer films according to the invention are furthermore suitable for producing a coating on a solid washing, cleaning or dishwashing compositions or on at least one solid component thereof. The polymer films dissolve at the start of the particular application (e.g. in the washing and dishwashing water), thus release the ingredients of the detergents and cleaners. If a washing and cleaning active polymer P2) is employed, (in particular a polymer composition obtainable by free-radical polymerization of a monomer composition M) which comprises at least one monomer A) selected from α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether PE) having an average of 3 to 12 alkylene oxide units per molecule) they contribute in dissolved form, on account of their dispersing, film-inhibiting, emulsifying and surface-active properties, to the washing, cleaning or dishwashing performance to a considerable extent. They improve the primary detergency, i.e. they help actively to remove the dirt from the fabric. Furthermore, they prevent a redeposition of removed dirt on the washed fabric, i.e. they have an anti-greying effect (secondary detergency). In particular they prevent the redeposition of particulate dirt, like clay particles, soot particles and color pigments. On account of their washing effect, they are suitable especially for the formulation of detergents.

The washing, cleaning and dishwashing portions according to the invention comprise, as covering and/or coating, at least one polymer film according to the invention. In the inside of this covering or coating, the washing, cleaning and dishwashing portions according to the invention comprise measured amounts of at least one washing-active or cleaning-active composition. In this connection, it is possible that the washing, cleaning and dishwashing portions comprise only a single washing- or cleaning-active composition. It is also possible that the washing, cleaning and dishwashing portions according to the invention comprise two or more than two different washing- or cleaning-active compositions. The different compositions can be surrounded by identical or different covering and/or coating. In this connection, at least one of the coverings and/or coatings comprises a polymer film according to the invention. The different compositions can be different as regards the concentration of the individual components (quantitive) and/or as regards the type of individual components (qualitative). It is particularly preferred that the components are adapted, as regards type and concentration, to the tasks which the active ingredient portion packs have to perform in the washing or cleaning operation.

The polymer films according to the invention are also advantageously suitable for producing so-called multichamber systems. Multichamber systems have 2, 3, 4, 5 or more than 5 chambers which each comprise a single or more than one component of a detergent or cleaner. In this connection, it may in principle be a single washing- or cleaning-active ingredient, a single auxiliary or any desired mixture of two or more than two active ingredients and/or auxiliaries. The ingredients of the individual chambers may be liquid, gel-like or solid. Multichamber systems are appropriate, for example, for separating from one another components of a detergent or cleaner that are incompatible or not very compatible. Thus, e.g. one chamber can comprise one or more enzymes(s) and another chamber can comprise at least one bleach. Multichamber systems are appropriate for example also in order to facilitate controlled release of a certain component e.g. at a certain time point in the washing or cleaning operation. For this, e.g. film materials of different material thickness can be used. Furthermore, individual chambers can be produced using a polymer film according to the invention and others can be produced using a conventional film different therefrom.

Wherever data relating to the qualitative and quantitative composition of detergents and cleaners is given hereinbelow, this should always comprise a formulation of this composition as multichamber system. In this connection, the chambers can in each case comprise one individual or several components of the formulation or the total amount of one component can be divided between two or more than two chambers.

The washing composition or cleaning composition or dishwashing composition portions according to the invention comprise at least one washing- or cleaning-active composition in the inside. These compositions may be any desired substances or substance mixtures relevant in connection with a washing or cleaning operation. These are primarily the actual washing compositions or cleaning compositions or dishwashing compositions with their individual components explained in more detail below.

In the context of the present invention, washing compositions are understood here as meaning those products which are used for the cleaning of flexible materials with high absorbency, e.g. of materials with a textile character, whereas cleaners in the context of the present invention are understood as meaning those products which are used for the cleaning of materials with a closed surface, i.e. with a surface which has no or only few and small pores and consequently has only low absorbency, if any.

Examples of flexible materials with high absorbency are those which comprise natural, synthetic or semisynthetic fiber materials or consist thereof and which accordingly generally have at least partially a textile character. The materials containing or consisting of fibers can in principle be present in any form occurring in use or in production and processing. For example, fibers can be present in an unarranged manner in the form of flocks or heaps, arranged in the form of threads, yarns, twines, or in the form of sheet structures such as nonwovens, loden materials or felt, wovens, knits in all conceivable types of binding. The fibers may be raw fibers or fibers in any desired stages of processing. Examples are natural protein or cellulose fibers, such as wool, silk, cotton, sisal, hemp or coconut fibers, or synthetic fibers such as, for example, polyester, polyamide or polyacrylonitrile fibers.

Examples of materials having only few and small pores, if any, and having zero or only low absorptivity are metal, glass, enamel or ceramic. Typical objects made of these materials are, for example, metallic sinks, cutlery, glass and porcelain dishware, bathtubs, washbasins, tiles, flags, cured synthetic resins, for example decorative melamine resin surfaces on kitchen furniture or painted metal surfaces, for example refrigerators and car bodies, printed circuit boards, microchips, sealed or painted woods, e.g. parquet or wall cladding, window frames, doors, plastics coverings such as floor coverings made of PVC or hard rubber, or rigid or flexible foams having substantially closed surfaces.

Examples of cleaning compositions which can comprise the polymer film according to the invention comprise washing and cleaning compositions, dishwashing compositions, such as hand dishwashing detergents or machine dishwashing detergents (ADW detergents), metal degreasers, glass cleaners, floor cleaners, all-purpose cleaners, high-pressure cleaners, neutral cleaners, alkaline cleaners, acidic cleaners, spray degreasers, dairy cleaners, commercial kitchen cleaners, apparatus cleaners in industry, especially the chemical industry, cleaners for car washing and also household all-purpose cleaners.

The washing composition or cleaning composition or dishwashing composition according to the invention may be portions, packaged in bags, of solid, liquid or gel-like washing or cleaning compositions. In a specific embodiment, they are so-called pouches (liquid tabs). Furthermore, they may be compressed moldings, such as tablets (“tabs”), blocks, briquettes, etc. In a specific embodiment, they are tablet-shaped washing compositions or cleaning compositions or dishwashing compositions.

In a further particularly preferred embodiment, they are then tableted dishwashing compositions, especially tableted machine dishwashing compositions. Tableted dishwashing compositions may be simple tabs or else what are called “2 in 1”, “3 in 1”, “5 in 1” or “7 in 1” products (multifunctional products). Further details of these formulations can be found in Hermann G. Hauthal, G. Wagner (eds.), Reinigungs-und Pflegemittel im Haushalt [Domestic Cleaning and Care Products], Verlag für chemische Industrie, H. Ziolkowsky GmbH, Augsburg 2003, Chapter 4.2, pages 161-184. “2 in 1” products comprise, as well as the customary constituents of machine dishwashing compositions, additionally a rinse aid. “3 in 1” products also comprise a water softener. “5 in 1” products generally also comprise a glass protector and a rinsing power enhancer. “7 in 1” products also comprise a stainless steel brightener and a deincrustation agent.

The washing or cleaning composition according to the invention preferably comprises the following constituents:
A) at least covering and/or coating comprising or consisting of a polymer film according to the invention,
B) at least one surfactant,
C) at least one builder,
D) optionally at least one bleach system,
E) optionally at least one further additive, which is preferably selected from enzymes, enzyme stabilizers, bases, corrosion inhibitors, antifoams, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, polymeric dispersants, antistats, ironing aids, hydrophobizing and impregnation agents, swelling and slip-resist agents and UV absorbers, and
F) optionally water.

In the context of the present invention, the builder C) also comprises compounds referred to as sequestrants, builder, complexing agent, chelator, chelating agent or water softener.

The bleach systems D) comprise, besides bleaches, optionally also bleach activators, bleach catalysts and/or bleach stabilizers.

Particularly preferably, the detergent and cleaner according to the invention comprises at least one enzyme and optionally at least one enzyme stabilizer as additive E).

A preferred embodiment relates to liquid or gel-like washing or cleaning compositions comprising:
A) 0.1 to 20% by weight of at least one covering and/or coating, comprising or consisting of a polymer film according to the invention,
B) 1 to 80% by weight of at least one surfactant,
C) 0.1 to 50% by weight of at least one builder,
D) 0 to 20% by weight of a bleach system,
E) 0.1 to 60% by weight of at least one further additive, which is preferably selected from enzymes, enzyme stabilizers, bases, corrosion inhibitors, antifoams, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, polymeric dispersants, antistats, ironing aids, hydrophobizing and impregnation agents, swelling and slip-resist agents and UV absorbers, and
F) 0 to 98.7% by weight of water.

The percent by weight data refer here to the total weight of the detergent and cleaner. The weight amounts of A) to F) add up to 100% by weight.

Preferably, the liquid or gel-like washing or cleaning compositions comprise up to 70% by weight of water, particularly preferably up to 50% by weight of water, in particular up to 30% by weight of water.

A further preferred embodiment relates to solid washing or cleaning compositions comprising:
A) 0.1 to 20% by weight of at least one covering and/or coating, comprising or consisting of a polymer film according to the invention,
B) 1 to 50% by weight of at least one surfactant,
C) 0.1 to 70% by weight of at least one builder,
D) 0 to 30% by weight of a bleach system,
E) 0.1 to 70% by weight of at least one further additive, which is preferably selected from enzymes, enzyme stabilizers, bases, corrosion inhibitors, antifoams, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, polymeric dispersants, antistats, ironing aids, hydrophobizing and impregnation agents, swelling and slip-resist agents and UV absorbers, and
   optionally water.

The percent by weight data refer here to the total weight of the detergent and cleaner. The weight amounts of A) to F) add up to 100% by weight.

### Component A)

As regards suitable and preferred polymer films according to the invention, reference is made to the statements above.

### Component B)

The detergents and cleaners according to the invention comprise as component B) at least one surfactant. Suitable surfactants B) are nonionic, anionic, cationic or amphoteric surfactants.

In the context of the present invention, surfactants B) that can be used are, for example, nonionic surfactants (NIS). The nonionic surfactants used are preferably alkoxylated alcohols. Preference is given to alkoxylated primary alcohols. Preferred alkoxylated alcohols are ethoxylated alcohols having preferably 8 to 18 carbon atoms in the alkyl radical and on average 1 to 12 mol of ethylene oxide (EO) per mole of alcohol. The alcohol radical can be linear or preferably 2-methyl-branched and can comprise linear and methyl-branched radicals in a mixture, as are customarily present in oxo alcohol radicals. Particular preference is given to alcohol ethoxylates with linear or branched radicals from alcohols of native or petrochemical origin having 12 to 18 carbon atoms, for example from coconut, palm, tallow fatty or oleyl alcohol, and on average 2 to 8 EO per mole of alcohol.

The ethoxylated alcohols are preferably selected from:
C₁₂C₁₄-alcohols with 3 EO, 5 EO, 7 EO or 9 EO,
C₉C₁₁-alcohols with 7 EO,
C₁₃-oxo alcohols with 3 EO, 5 EO, 7 EO or 9 EO,
C₁₃C₁₅-alcohols with 3 EO, 5 EO, 7 EO or 9 EO,
C₁₂C₁₈-alcohols with 3 EO, 5 EO, 7 EO or 9 EO and mixtures thereof,
2-propylheptanol with 3 EO, 4 EO, 5 EO, 6 EO, 7 EO, 8 EO and 9 EO,
   and mixtures of two or more than two of the aforementioned ethoxylated alcohols.

A preferred mixture of nonionic surfactants is a mixture of C₁₂C₁₄-alcohol (lauryl alcohol/myristyl alcohol) with 3 EO and C₁₂C₁₈-alcohol (lauryl alcohol/myristyl alcohol/cetyl alcohol/stearyl alcohol) with 7 EO. Preference is also given to mixtures of short-chain alcohol ethoxylates (e.g. 2-propylheptanol with 7 EO) and long-chain alcohol ethoxylates (e.g. C₁₆C₁₈ with 7 EO).

The stated degrees of ethoxylation are statistical averages (number averages, Mn), which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO. Examples thereof are tallow fatty alcohol with 14 EO, 25 EO, 30 EO or 40 EO. Nonionic surfactants which comprise ethylene oxide (EO) and propylene oxide (PO) groups together in the molecule can also be used. In this connection, it is possible to use block copolymers with EO-PO block units or PO-EO block units, but also EO-PO-EO copolymers or PO-EO-PO copolymers. It is of course also possible to use mixed alkoxylated nonionic surfactants in which EO and PO units are not blockwise but randomly distributed. Such products are obtainable by the simultaneous action of ethylene oxide and propylene oxide on fatty alcohols.

Surfactants suitable as component B) are also polyetherols, preferably with a number-average molecular weight of at least 200 g/mol.

Suitable polyetherols can be linear or branched, preferably linear. Suitable polyetherols have generally a number-average molecular weight in the range from about 200 to 100 000, preferably 300 to 50 000, particularly preferably 500 to 40 000. Suitable polyetherols are, for example, water-soluble or water-dispersible nonionic polymers which have alkylene oxide repeat units. Preferably, the fraction of alkylene oxide repeat units is at least 30% by weight, based on the total weight of the compound. Suitable polyetherols are polyalkylene glycols, such as polyethylene glycols, polypropylene glycols, polytetrahydrofurans and alkylene oxide copolymers. Suitable alkylene oxides for producing alkylene oxide copolymers are e.g. ethylene oxide, propylene oxide, epichlorohydrin, 1,2- and 2,3-butylene oxide. Of suitability are, for example, copolymers of ethylene oxide and propylene oxide, copolymers of ethylene oxide and butylene oxide, and copolymers of ethylene oxide, propylene oxide and at least one butylene oxide. The alkylene oxide copolymers can comprise the polymerized-in alkylene oxide units in randomly distributed form or in the form of blocks. Preferably, the fraction of repeat units derived from ethylene oxide in the ethylene oxide/propylene oxide copolymers is 40 to 99% by weight. Particular preference is given to ethylene oxide homopolymers and ethylene oxide/propylene oxide copolymers.

Moreover, further nonionic surfactants that can be used are also alkyl glycosides of the general formula (IV)

R¹⁰O(G)ᵢ (IV)

in which
R¹⁰ is a primary straight-chain or methyl-branched aliphatic radical having 8 to 22 carbon atoms,
G is a glycoside unit having 5 or 6 carbon atoms, and
i is any desired number between 1 and 10.

In the compounds of the formula (IV), R¹⁰ is preferably a 2-methyl-branched aliphatic radical having 8 to 22, preferably 12 to 18 carbon atoms.

G is preferably glucose.

The degree of oligomerization i, which indicates the distribution of monoglycosides and oligoglycosides, is preferably in a range from 1.2 to 1.4.

A further class of nonionic surfactants used with preference in the context of the present invention and which are used either as the sole nonionic surfactant or in combination with other nonionic surfactants are alkoxylated, preferably ethoxylated or ethoxylated and propoxylated fatty acid alkyl esters, preferably having 1 to 4 carbon atoms in the alkyl chain. Particular preference is given to fatty acid methyl esters, as are described, for example, in the Japanese patent application JP 58/217598, or which are produced preferably in accordance with the process described in the International patent application WO 90/13533.

Also suitable as nonionic are amine oxides, for example N-cocoalkyl-N,N-dimethylamine oxide and N-tallowalkyl-N,N-dihydroxyethylamine oxide, and fatty acid alkanolamides. These nonionic surfactants are preferably used as a mixture with alkoxylated alcohols. Preference is given to the mixture with ethoxylated fatty alcohols. The weight amount of these nonionic surfactants is preferably not more than that of the ethoxylated fatty alcohols, in particular not more than half thereof.

Further suitable surfactants B) are polyhydroxy fatty acid amides of the formula (V)

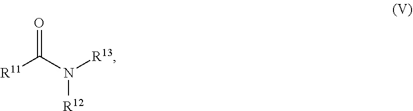

in which the group R¹¹—C(═O) is an aliphatic acyl radical having 6 to 22 carbon atoms, R¹² is hydrogen, an alkyl radical with 1 to 4 carbon atoms or a hydroxyalkyl radical having 1 to 4 carbon atoms, and R¹³ is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride. The group of polyhydroxy fatty acid amides include in this connection also compounds of the formula (VI)

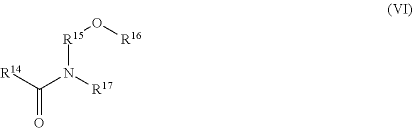

in which R¹⁴ is a linear or branched alkyl or alkenyl radical having 7 to 12 carbon atoms, R¹⁵ is a linear, branched or cyclic alkylene radical having 2 to 8 carbon atoms or an arylene radical having 6 to 8 carbon atoms, and R¹⁶ is a linear, branched or cyclic alkyl radical or an aryl radical or an oxyalkyl radical having 1 to 8 carbon atoms, where C₁-C₄-alkyl or phenyl radicals are preferred, and R¹⁷ is a linear polyhydroxyalkyl radical whose alkyl chain is substituted with at least two hydroxyl groups, or alkoxylated, preferably ethoxylated or propoxylated derivatives of this radical. R¹⁷ is preferably obtained by a reductive amination of a sugar, for example glucose, fructose, maltose, lactose, galactose, mannose or xylose. The N-alkoxy- or N-aryloxy-substituted compounds can then be converted to the desired polyhydroxy fatty acid amides for example in accordance with WO 95/07331 by reaction with fatty acid methyl esters in the presence of an alkoxide as catalyst.

Suitable surfactants B) are also anionic surfactants. Typical examples of anionic surfactants are soaps, alkylsulfonates, alkylbenzenesulfonates, olefinsulfonates, methyl ester sulfonates, sulfo fatty acids, alkyl sulfates, mono- and dialkyl sulfosuccinates, mono- and dialkyl sulfosuccinamates, sulfotriglycerides, amide soaps, ethercarboxylic acids and salts thereof, fatty acid isethionates, fatty acid sarcosinates, fatty acid taurides, N-acylamino acids, such as, for example, acyl lactylates, acyl tartrates, acyl glutamates and acyl aspartates, alkyl oligoglucoside sulfates, alkylglucose carboxylates, protein fatty acid condensates and alkyl (ether) phosphates.

A first preferred embodiment is anionic surfactants of the sulfonate and sulfate types. Preferred surfactants of the sulfonate type are C₉-C₁₃-alkylbenzenesulfonates, olefinsulfonates, i.e. mixtures of alkene- and hydroxyalkanesulfonates, and also disulfonates, as are obtained, for example, from C₁₂-C₁₈-monoolefins with terminal or pendent double bond by sulfonation with gaseous sulfur trioxide and subsequent alkaline or acidic hydrolysis of the sulfonation products. Also of suitability are alkanesulfonates, which are obtained from C₁₂-C₁₈-alkanes for example by sulfochlorination or sulfoxidation with subsequent hydrolysis and/or neutralization. Likewise of suitability are also the esters of α-sulfo fatty acids (estersulfonates), for example the α-sulfonated methyl esters of hydrogenated coconut, palm kernel or tallow fatty acids. Further suitable anionic surfactants are sulfated fatty acid glycerol esters. Fatty acid glycerol esters are to be understood as meaning, inter alia, the mono-, di- and triesters, and mixtures thereof, as are obtained during the production by esterification of a monoglycerol with 1 to 3 mol of fatty acid or during the transesterification of triglycerides with 0.3 to 2 mol of glycerol.

Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid. Preferred alk(en)yl sulfates are the alkali metal and in particular the sodium salts of the sulfuric acid half-esters of C₁₂-C₁₈-fatty alcohols, for example of coconut fatty alcohol, tallow fatty alcohol, lauryl, myristyl, cetyl or stearyl alcohol or of the C₁₀-C₂₀-oxo alcohols and the half-esters of secondary C₁₀-C₂₀-alcohols. Preference is furthermore given to alk(en)yl sulfates which comprise a synthetic straight-chain C₁₀-C₂₀-alkyl radical produced on a petrochemical basis. These have an analogous degradation behavior to the equivalent compounds based on fatty chemical raw materials. From the point of view of washing, the C₁₂-C₁₆-alkyl sulfates and C₁₂-C₁₅-alkyl sulfates and C₁₄-C₁₅-alkyl sulfates are preferred. 2,3-Alkyl sulfates, which are prepared for example in accordance with the U.S. Pat. Nos. 3,234,258 or 5,075,041 and can be obtained as commercial products of the Shell Oil Company under the name DAN®, are also suitable anionic surfactants. The sulfuric acid monoesters of the straight-chain or branched C₇-C₂₁-alcohols ethoxylated with 1 to 6 mol of ethylene oxide, such as 2-methyl-branched C₉-C₁₁-alcohols having on average 3.5 mol of ethylene oxide (EO) or C₁₂-C₁₈-fatty alcohols having 1 to 4 EO, inter alia, are also suitable. They are usually used in cleaners only in relatively small amounts, for example in amounts from 1 to 5% by weight, on account of their high foam behavior. Further suitable anionic surfactants in the context of the present invention are also the salts of alkylsulfosuccinic acid, which are also referred to as sulfosuccinates or as sulfosuccinic acid esters and are the monoesters and/or diesters of sulfosuccinic acid with alcohols, preferably fatty alcohols and in particular ethoxylated fatty alcohols. Preferred sulfosuccinates comprise C₈-C₁₈-fatty alcohol radicals or mixtures of these. Particularly preferred sulfosuccinates comprise a fatty alcohol radical which is derived from ethoxylated fatty alcohols. Here, in turn sulfosuccinates whose fatty alcohol radicals are derived from ethoxylated fatty alcohols with a narrow homolog distribution are particularly preferred. It is likewise also possible to use alk(en)ylsuccinic acid having preferably 8 to 18 carbon atoms in the alk(en)yl chain or salts thereof.

Particularly preferred anionic surfactants are soaps. Of suitability are saturated and unsaturated fatty acid soaps, such as the salts of lauric acid, myristic acid, palmitic acid, stearic acid, (hydrogenated) erucic acid and behenic acid, and also in particular soap mixtures derived from natural fatty acids, for example coconut, palm kernel, olive oil or tallow fatty acids.

The anionic surfactants including the soaps can be present in the form of their sodium, potassium or ammonium salts, and also as soluble salts of organic bases, such as mono-, di- or triethanolamine. Preferably, the anionic surfactants are present in the form of their sodium or potassium salts, in particular in the form of the sodium salts.

Suitable surfactants B) are also cationic surfactants. Particularly preferred cationic surfactants are:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines esterified with C₈-C₂₂-carboxylic acids;
imidazoline quats, in particular 1-alkylimidazolinium salts of the formulae VII or VIII

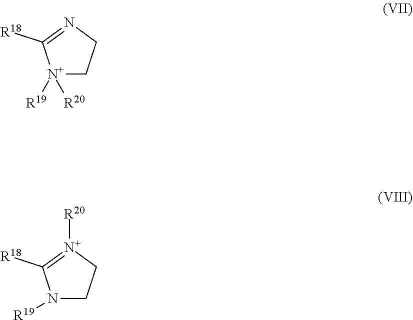

where the variables have the following meaning:
R¹⁸ is C₁-C₂₅-alkyl or C₂-C₂₅-alkenyl,
R¹⁹ is C₁-C₄-alkyl or hydroxy-C₁-C₄-alkyl,
R²⁰ is C₁-C₄-alkyl, hydroxy-C₁-C₄-alkyl or a radical R²¹—(CO)—R²²—(CH₂)ᵣ, where R²¹ is H or C₁-C₄-alkyl, R²¹ is —O— or —NH— and r is 2 or 3,
   where at least one radical R¹⁸ is a C₇-C₂₂-alkyl radical.

The surfactants B) can also be amphoteric surfactants. Suitable amphoteric surfactants are alkylbetaines, alkylamidobetaines, alkylsulfobetaines, aminopropionates, aminoglycinates and amphoteric imidazolium compounds. For example, it is possible to use cocodimethylsulfopropylbetaine, laurylbetaine, cocamidopropylbetaine, sodium cocamphopropionate or tetradecyldimethylamine oxide.

The content of surfactants in liquid and gel-like detergent and cleaner compositions is preferably 2 to 75% by weight and in particular 5 to 65% by weight, in each case based on the total composition.

The content of surfactants in solid detergent and cleaner compositions is preferably 2 to 40% by weight and in particular 5 to 35% by weight, in each case based on the total composition.

### Component C

Builders, which are sometimes also referred to as sequestrants, builder material, complexing agent, chelator, chelating agent or softener, bind alkaline earth metals and other water-soluble metal salts without precipitating. They help to break up dirt, disperse dirt particles, help dirt to dissolve and sometimes have their own washing effect.

Suitable builders can either be organic or inorganic in nature. Examples are alumosilicates, carbonates, phosphates and polyphosphates, polycarboxylic acids, polycarboxylates, hydroxycarboxylic acids, phosphonic acids, e.g. hydroxyalkylphosphonic acids, phosphonates, aminopolycarboxylic acids and salts thereof and polymeric compounds containing carboxylic acid groups, and salts thereof.

Suitable inorganic builders are, for example, crystalline or amorphous alumosilicates with ion-exchanging properties, such as zeolites. Different types of zeolites are suitable, in particular zeolites A, X, B, P, MAP and HS in their Na form or in forms in which Na is in part exchanged for other cations such as Li, K, Ca, Mg or ammonium. Suitable zeolites are described for example in U.S. Pat. No. 4,604,224. Crystalline silicates suitable as builders are, for example, disilicates or sheet silicates, e.g. 5-Na₂Si₂O₅ or B—Na₂Si₂O₅ (SKS 6 or SKS 7). The silicates can be used in the form of their alkali metal, alkaline earth metal or ammonium salts, preferably as Na, Li and Mg silicates. Amorphous silicates, such as, for example, sodium metasilicate, which has a polymeric structure, or amorphous disilicate (Britesil® H 20 manufacturer: Akzo) can likewise be used. Among these, preference is given to sodium disilicate.

Suitable inorganic builder substances based on carbonate are carbonates and hydrogencarbonates. These can be used in the form of their alkali metal, alkaline earth metal or ammonium salts. Preference is given to using Na, Li and Mg carbonates and hydrogencarbonates, in particular sodium carbonate and/or sodium hydrogencarbonate.

Customary phosphates used as inorganic builders are alkali metal orthophosphates and/or polyphosphates, such as e.g. pentasodium triphosphate.

Suitable organic builders are, for example, C₄-C₃₀-di-, -tri- and -tetracarboxylic acids, such as e.g. succinic acid, propanetricarboxylic acid, butanetetracarboxylic acid, cyclopentanetetracarboxylic acid and alkyl- and alkenylsuccinic acids with C₂-C₂₀-alkyl or -alkenyl radicals.

Suitable organic builders are also hydroxycarboxylic acids and polyhydroxycarboxylic acids (sugar acids). These include C₄-C₂₀-hydroxycarboxylic acids such as e.g. malic acid, tartaric acid, gluconic acid, mucic acid, lactic acid, glutaric acid, citric acid, tartronic acid, glucoheptonic acid, lactobionic acid and sucrosemono-, -di- and -tricarboxylic acid. Among these, preference is given to citric acid and salts thereof.

Suitable organic builders are also phosphonic acids, such as e.g. hydroxyalkylphosphonic acids, aminophosphonic acids and the salts thereof. These include e.g. phosphonobutanetricarboxylic acid, aminotrismethylenephosphonic acid, ethylenediaminetetraethylenephosphonic acid, hexamethylenediaminetetramethylenephosphonic acid, diethylenetriaminepentamethylenephosphonic acid, morpholinomethanediphosphonic acid, 1-hydroxy-C₁- to C₁₀-alkyl-1,1-diphosphonic acids such as 1-hydroxyethane-1,1-diphosphonic acid. Among these, preference is given to 1-hydroxyethane-1,1-diphosphonic acid and salts thereof.

Suitable organic builders are also aminopolycarboxylic acids, such as nitrilotriacetic acid (NTA), nitrilomonoaceticdipropionic acid, nitrilotripropionic acid, β-alaninediacetic acid (β-ADA), ethylenediaminetetraacetic acid (EDTA), diethylenetriaminepentaacetic acid, 1,3-propylenediaminetetraacetic acid, 1,2-propylenediaminetetraacetic acid, N-(alkyl)-ethylenediaminetriacetic acid, N-(hydroxyalkyl)-ethylenediaminetriacetic acid, ethylenediaminetriacetic acid, cyclohexylene-1,2-diaminetetraacetic acid, iminodisuccinic acid, hydroxyiminodisuccinic acid, ethylenediaminedisuccinic acid, serinediacetic acid, isoserinediacetic acid, L-asparaginediacetic acid, L-glutaminediacetic acid, methylglycinediacetic acid (MGDA) and the salts of the aforementioned aminopolycarboxylic acids. Preference is given to methylglycinediacetic acid, glutaminediacetic acid and salts thereof. The salts of methylglycinediacetic acid can be present as racemate, i.e. D- and L-enantiomers are present in equimolar mixture, or one enantiomer, e.g. the L-enantiomer, can be present in excess.

Suitable organic builders are also polymeric compounds containing carboxylic acid groups such as acrylic acid homopolymers. These preferably have a number-average molecular weight in the range from 800 to 70 000 g/mol, particularly preferably 900 to 50 000 g/mol, in particular 1000 to 20 000 g/mol, specifically 1000 to 10 000 g/mol. In this context, the term acrylic acid homopolymer also comprises polymers in which the carboxylic acid groups are present in partially or completely neutralized form. These include acrylic acid homopolymers in which the carboxylic acid groups are present partly or completely in the form of alkali metal salts or ammonium salts. Preference is given to acrylic acid homopolymers in which the carboxylic acid groups are present partly or completely in the form of sodium salts.

Suitable polymeric compounds containing carboxylic acid groups are also oligomaleic acids, as described for example in EP-A 451 508 and EP-A 396 303.

Suitable polymeric compounds containing carboxylic acid groups are also terpolymers of unsaturated C₄-C₈-dicarboxylic acids, where monoethylenically unsaturated monomers from the group (i) mentioned below in amounts of up to 95% by weight, from the group (ii) in amounts of up to 60% by weight and from the group (iii) in amounts of up to 20% by weight, can be polymerized-in as comonomers. Suitable unsaturated C₄-C₈-dicarboxylic acids here are, for example, maleic acid, fumaric acid, itaconic acid and citraconic acid. Preference is given to maleic acid. The group (i) comprises monoethylenically unsaturated C₃-C₈-monocarboxylic acids such as e.g. acrylic acid, methacrylic acid, crotonic acid and vinylacetic acid. From the group (i), preference is given to using acrylic acid and methacrylic acid. The group (ii) comprises monoethylenically unsaturated C₂-C₂₂-olefins, vinyl alkyl ethers with C₁-C₈-alkyl groups, styrene, vinyl esters of C₁-C₈-carboxylic acids, (meth)acrylamide and vinylpyrrolidone. From the group (ii), preference is given to using C₂-C₆-olefins, vinyl alkyl ethers with C₁-C₄-alkyl groups, vinyl acetate and vinyl propionate. If the polymers of group (ii) comprise vinyl esters in polymerized-in form, these may also be present partly or completely hydrolyzed to give vinyl alcohol structural units. Suitable co- and terpolymers are known for example from U.S. Pat. No. 3,887,806, and DE-A 4313909. The group (iii) comprises (meth)acrylic esters of C₁-C₈-alcohols, (meth)acrylonitrile, (meth)acrylamides of C₁-C₈-amines, N-vinylformamide and N-vinylimidazole.

Suitable polymeric compounds containing carboxylic acid groups are also homopolymers of the monoethylenically unsaturated C₃-C₈-monocarboxylic acids such as e.g. acrylic acid, methacrylic acid, crotonic acid and vinylacetic acid, in particular of acrylic acid and methacrylic acid, copolymers of dicarboxylic acids, such as e.g. copolymers of maleic acid or itaconic acid and acrylic acid in the weight ratio 10:90 to 95:5, particularly preferably those in the weight ratio 30:70 to 90:10 with molar masses from 1000 to 150 000; terpolymers of maleic acid, acrylic acid and a vinyl ester of a C₁-C₃-carboxylic acid in the weight ratio 10 (maleic acid):90 (acrylic acid+vinyl ester) to 95 (maleic acid):10 (acrylic acid+vinyl ester), where the weight ratio of acrylic acid to the vinyl ester can vary in the range from 30:70 to 70:30; copolymers of maleic acid with C₂-C₈-olefins in the molar ratio 40:60 to 80:20, where copolymers of maleic acid with ethylene, propylene or isobutene in the molar ratio 50:50 are particularly preferred.

Suitable polymeric compounds containing carboxylic acid groups are also copolymers of 50 to 98% by weight of ethylenically unsaturated weak carboxylic acids with 2 to 50% by weight of ethylenically unsaturated sulfonic acids, as are described for example in EP-A-0877002. Suitable weak ethylenically unsaturated carboxylic acids are in particular C₃-C₆-monocarboxylic acids, such as acrylic acid and methacrylic acid. Suitable ethylenically unsaturated sulfonic acids are 2-acetylamidomethyl-1-propanesulfonic acid, 2-methacrylic amido-2-methyl-1-propanesulfonic acid, 2-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethylacrylamide, sulfomethylmethacrylamide and salts of these acids. The copolymers can also comprise, in polymerized-in form, 0 to 30% by weight of ethylenically unsaturated C₄-C₈-dicarboxylic acids, such as maleic acid, as well as 0 to 30% by weight of at least one monomer which is copolymerizable with the aforementioned monomers. The latter is, for example, C₁-C₄-alkyl esters of (meth)acrylic acid, C₁-C₄-hydroxyalkyl esters of (meth)acrylic acid, acrylamide, alkyl-substituted acrylamide, N,N-dialkyl-substituted acrylamide, vinylphosphonic acid, vinyl acetate, allyl alcohols, sulfonated allyl alcohols, styrene and other vinylaromatics, acrylonitrile, N-vinylpyrrolidone, N-vinylformamide, N-vinylimidazole or N-vinylpyridine. The weight-average molecular weight of these copolymers is in the range from 3000 to 50 000 Daltons. Copolymers with about 77% by weight of at least one ethylenically unsaturated C₃-C₆-monocarboxylic acid and about 23% by weight of at least one ethylenically unsaturated sulfonic acid are particularly suitable.

Graft polymers of unsaturated carboxylic acids on low molecular weight carbohydrates or hydrogenated carbohydrates, cf. U.S. Pat. No. 5,227,446, DE-A 4415623 and DE-A 4313909, are likewise suitable. Suitable unsaturated carboxylic acids here are, for example, maleic acid, fumaric acid, itaconic acid, citraconic acid, acrylic acid, methacrylic acid, crotonic acid and vinylacetic acid, and mixtures of acrylic acid and maleic acid, which are grafted on in amounts of from 40 to 95% by weight, based on the component to be grafted. For the modification, additionally up to 30% by weight, based on the component to be grafted, of further monoethylenically unsaturated monomers can be present in polymerized-in form. Suitable modifying monomers are the aforementioned monomers of groups (ii) and (iii). Suitable graft bases are degraded polysaccharides such as e.g. acidically or enzymatically degraded starches, inulins or cellulose, protein hydrolyzates and reduced (hydrogenated or reductively aminated) degraded polysaccharides such as e.g. mannitol, sorbitol, aminosorbitol and N-alkylglucamine, and also polyalkylene glycols with molar masses having up to M_{W}=5000 such as e.g. polyethylene glycols, ethylene oxide/propylene oxide or ethylene oxide/butylene oxide or ethylene oxide/propylene oxide/butylene oxide block copolymers and alkoxylated mono- or polyhydric C₁-C₂₂-alcohols (cf. U.S. Pat. No. 5,756,456).

Likewise of suitability are polyglyoxylic acids, as are described for example in EP-B-001004, U.S. Pat. No. 5,399,286, DE-A-4106355 and EP-A-656914. The end groups of the polyglyoxylic acids can have different structures.

Furthermore, polyamidocarboxylic acids and modified polyamidocarboxylic acids are suitable; these are known for example from EP-A-454126, EP-B-511037, WO-A94/01486 and EP-A-581452.

Polyaspartic acids and their alkali metal salts or cocondensates of aspartic acid with other amino acids, e.g. with glycine, glutamic acid or lysine, C₄-C₂₅-mono- or -dicarboxylic acids and/or C₄-C₂₅-mono- or -diamines can also be used as polymeric compounds containing carboxylic acid groups.

Among the polymeric compounds containing carboxylic acid groups, preference is given to polyacrylic acids also in partially or completely neutralized form.

Suitable organic builders are also iminodisuccinic acid, oxydisuccinic acid, aminopolycarboxylates, alkylpolyaminocarboxylates, aminopolyalkylenephosphonates, polyglutamates, hydrophobically modified citric acid such as e.g. agaricic acid, poly-[alpha]-hydroxyacrylic acid, N-acylethylenediamine triacetates such as lauroylethylenediamine triacetate and alkylamides of ethylenediaminetetraacetic acid such as EDTA tallow amide.

Furthermore, it is also possible to use oxidized starches as organic builders.

### Component D)

The bleach systems D) comprise at least one bleaching agent and optionally at least one further component selected from bleach activators, bleach catalysts and bleach stabilizers.

Suitable bleaching agents are, for example, percarboxylic acids, e.g. diperoxododecanedicarboxylic acid, phthalimidopercaproic acid or monoperoxophthalic acid or -terephthalic acid, salts of percarboxylic acids, e.g. sodium percarbonate, adducts of hydrogen peroxide onto inorganic salts, e.g. sodium perborate monohydrate, sodium perborate tetrahydrate, sodium carbonate perhydrate or sodium phosphate perhydrate, adducts of hydrogen peroxide onto organic compounds, e.g. urea perhydrate, or of inorganic peroxo salts, e.g. alkali metal persulfates, or peroxodisulfates.

Suitable bleach activators are, for example, polyacylated sugars, e.g. pentaacetyl glucose; acyloxybenzenesulfonic acids and their alkali metal and alkaline earth metal salts, e.g. sodium p-nonanoyloxybenzenesulfonate or sodium p-benzoyloxybenzene sulfonate; —N,N-diacylated and N,N,N′,N′-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethyl hydantoin; N-alkyl-N-sulfonylcarboxamides, e.g. N-methyl-N-mesylacetamide or N-methyl-N-mesylbenzamide; N-acylated cyclic hydrazides, acylated triazoles or urazoles, e.g. monoacetylmaleic acid hydrazide; O,N,N-trisubstituted hydroxylamines, e.g. O-benzoyl-N,N-succinylhydroxylamine, O-acetyl-N,N-succinylhydroxylamine or O,N,N-triacetylhydroxylamine; N,N′-diacylsulfurylamides, e.g. N,N′-dimethyl-N,N′-diacetylsulfurylamide or N,N′-diethyl-N,N′-dipropionylsulfurylamide; acylated lactams such as, for example, acetylcaprolactam, octanoylcaprolactam, benzoylcaprolactam or carbonylbiscaprolactam; anthranil derivatives such as e.g. 2-methylanthranil or 2-phenylanthranil; triacylcyanurates, e.g. triacetyl cyanurate or tribenzoyl cyanurate; oxime esters and bisoxime esters such as e.g. O-acetylacetone oxime or bisisopropyliminocarbonate; carboxylic acid anhydrides, e.g. acetic anhydride, benzoic anhydride, m-chlorobenzoic anhydride or phthalic anhydride; enol esters such as e.g. isopropenyl acetate; 1,3-diacyl-4,5-diacyloxyimidazolines, e.g. 1,3-diacetyl-4,5-diacetoxyimidazoline; tetraacetylglycoluril and tetrapropionylglycoluril; diacylated 2,5-diketopiperazines, e.g. 1,4-diacetyl-2,5-diketopiperazine; ammonium-substituted nitriles such as e.g. N-methylmorpholinium acetonitrile methylsulfate; acylation products of propylenediurea and 2,2-dimethylpropylenediurea, e.g. tetraacetylpropylenediurea; α-acyloxypolyacylmalonamides, e.g. α-acetoxy-N,N′-diacetylmalonamide; diacyldioxohexahydro-1,3,5-triazines, e.g. 1,5-diacetyl-2,4-dioxohexahydro-1,3,5-triazine; benz(4H)-1,3-oxazin-4-ones with alkyl radicals, e.g. methyl, or aromatic radicals e.g. phenyl, in the 2 position.

A bleach system of bleaching agents and bleach activators can optionally also comprise bleach catalysts. Suitable bleach catalysts are, for example, quaternized imines and sulfonimines, which are described for example in U.S. Pat. No. 5,360,569 and EP-A 453 003. Particularly effective bleach catalysts are manganese complexes, which are described for example in WO-A 94/21777. Such compounds are incorporated in the case of their use in detergents and cleaners at most in amounts up to 1.5% by weight, in particular up to 0.5% by weight, in the case of very active manganese complexes in amounts up to 0.1% by weight. Besides the described bleach system of bleaching agents, bleach activators and optionally bleach catalysts, the use of systems with enzymatic peroxide release or of photoactivated bleach systems is also possible for the detergents and cleaners according to the invention.

### Component E)

Suitable enzymes (=component E1) are those as are customarily used as industrial enzymes. These include both enzymes with optimum activity in the neutral to alkaline pH range, as well as enzymes with optimum activity in the acidic pH range. In a special embodiment, component E1) also comprises at least one enzyme stabilizer. Suitable enzymes stabilizers E1) are those that are customarily used.

The enzymes are preferably selected from aminopeptidases, amylases, arabinases, carbohydrases, carboxypeptidases, catalases, cellulases, chitinases, cutinases, cyclodextringlycosyltransferases, deoxyribonucleases, esterases, galactanases, alphagalactosidases, beta-galactosidases, glucanases, glucoamylases, alpha-glucosidases, beta-glucosidases, haloperoxidases, hydrolaseinvertases, isomerases, keratinases, laccases, lipases, mannanases, mannosidases, oxidases, pectinolytic enzymes, peptidoglutaminases, peroxidases, peroxygenases, phytases, polyphenoloxidases, proteolytic enzymes, ribonucleases, transglutaminases, transferases, xylanases and mixtures thereof.

The enzymes are specifically selected from hydrolases, such as proteases, esterases, glucosidases, lipases, amylases, cellulases, mannanases, other glycosylhydrolases and mixtures of the aforementioned enzymes. All of these hydrolases contribute to the soil dissolving and removal of protein-, grease- or starch-containing soilings. Oxireductases can also be used for bleaching. Of particularly good suitability are enzymatic active ingredients obtained from bacterial strains or fungi such as Bacillus subtilis, Bacillus licheniformis, Streptomyceus griseus and Humicola insolens.

Preferred enzymes are described in more detail below:

### Proteases:

Suitable proteolytic enzymes (proteases) can in principle be of animal, vegetable or microbial origin. Preference is given to proteolytic enzymes of microbial origin. These also include chemically or genetically modified mutants.

### Lipases:

Suitable lipases can in principle originate from bacteria or fungi. These also include chemically or genetically modified mutants.

### Amylases:

In principle, all α- and/or β-amylases are suitable. Suitable amylases can in principle originate from bacteria or fungi. These also include chemically or genetically modified mutants.

### Cellulases:

In principle, all cellulases are suitable. Suitable cellulases can in principle originate from bacteria or fungi. These also include chemically or genetically modified mutants.

### Peroxidases/Oxidases:

Suitable peroxidases/oxidases can in principle originate from plants, bacteria or fungi. These also include chemically or genetically modified mutants.

### Lyases:

In principle, all lyases are suitable. Suitable lyases can in principle originate from bacteria or fungi. These also include chemically or genetically modified mutants.

Compositions according to the invention can comprise further enzymes, which are summarized under the term hemicellulases. These include, for example, mannanases, xanthan lyases, pectin lyases (=pectinases), pectinesterases, xyloglucanases (=xylanases), pullulanases and β-glucanases.

Preferably, the detergent or cleaner according to the invention comprises at least one enzyme which is selected from proteases, amylases, mannanases, cellulases, lipases, pectin lyases and mixtures thereof.

Preferably, the detergent or cleaner according to the invention comprises at least one protease and/or amylase.

Preferably, the detergent, cleaner and dishwashing detergent according to the invention comprises an enzyme mixture. For example, preference is given to enzyme mixtures which comprise or consist of the following enzymes:
protease and amylase,
protease and lipase (or lipolytically acting enzymes),
protease and cellulase,
amylase, cellulase and lipase (or lipolytically acting enzymes),
protease, amylase and lipase (or lipolytically acting enzymes),
protease, lipase (or lipolytically acting enzymes) and cellulase.

The enzymes can be adsorbed onto carrier substances in order to protect them from premature decomposition.

The detergent or cleaner according to the invention can optionally also comprise enzyme stabilizers E1). These include e.g. calcium propionate, sodium formate, boric acids, boronic acids and salts thereof, such as 4-formylphenylboronic acid, peptides and peptide derivatives, such as e.g. peptide aldehydes, polyols, such as 1,2-propanediol, and mixtures thereof.

The washing or cleaning compositions according to the invention comprise the enzymes preferably in an amount of from 0.1 to 5% by weight, particularly preferably 0.12 to 2.5% by weight, based on the total weight of the washing or cleaning compositions.

In order to impart the desired viscosity to liquid and specifically aqueous compositions, at least one thickener (=component E2) can additionally be used as component E).

Of suitability in principle are any known thickeners (rheology modifiers) provided they do not have a negative influence on the effect of the detergent and cleaner. Suitable thickeners may either be of natural origin or synthetic in nature.

Examples of thickeners of natural origin are xanthan, carob seed flour, guar flour, carrageenan, agar, tragacanth, gum Arabic, alginates, modified starches, such as hydroxyethyl starch, starch phosphate esters or starch acetates, dextrins, pectins and cellulose derivatives, such as carboxymethylcellulose, hydroxyethylcellulose, hydroxypropylcellulose, hydroxypropylmethylcellulose, methylcellulose and the like.

Thickeners of natural origin are also inorganic thickeners, such as polysilicic acids and clay minerals, e.g. sheet silicates, like also the silicates specified under the builders.

Examples of synthetic thickeners are polyacrylic and polymethacrylic compounds, such as (partially) crosslinked homopolymers of acrylic acid, for example with an allyl ether of sucrose or pentaerythritol or propylene-crosslinked homopolymers of acrylic acid (carbomer), e.g. the Carbopol® grades from BF Goodridge (e.g. Carbopol® 676, 940, 941, 934 or the like) or the Polygel® grades from 3V Sigma (e.g. Polygel® DA), copolymers of ethylenically unsaturated mono- or dicarboxylic acids, for example terpolymers of acrylic acid, methacrylic acid or maleic acid with methyl or ethyl acrylate and a (meth)acrylate derived from long-chain ethoxylated alcohols, for example the Acusol® grades from Rohm & Haas (e.g. Acusol® 820 or 1206A), copolymers of two or more monomers which are selected from acrylic acid, methacrylic acid and their C₁-C₄-alkyl esters, e.g. copolymers of methacrylic acid, butyl acrylate and methyl methacrylate or of butyl acrylate and methyl methacrylate, e.g. the Aculyn® and Acusol® grades from Rohm & Haas (e.g. Aculyn® 22, 28 or 33 and Acusol® 810, 823 and 830), or crosslinked high molecular weight acrylic acid copolymers, for example with an allyl ether of sucrose or pentaerythritol-crosslinked copolymers of C₁₀-C₃₀-alkyl acrylates with one or more comonomers which are selected from acrylic acid, methacrylic acid and their C₁-C₄-alkyl esters (e.g. Carbopol® ETD 2623, Carbopol® 1382 or Carbopol® AQUA 30 from Rohm & Haas).

Examples of synthetic thickeners are also reaction products of maleic acid polymers with ethoxylated long-chain alcohols, e.g. the Surfonic L series from Texaco Chemical Co. or Gantrez AN-119 from ISP; polyethylene glycols, polyamides, polyimines and polycarboxylic acids.

Also of suitability are mixtures of the aforementioned thickeners.

Preferred thickeners are xanthans and the aforementioned polyacrylic and polymethacrylic compounds.

Suitable organic solvents (=component E3) are selected from mono- or polyhydric alcohols, alkanolamines or glycol ethers. Preferably, they are selected from ethanol, n- or isopropanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or -ethyl ether, diisopropylene glycol monomethyl or -ethyl ether, methoxy, ethoxy or butoxy triglycol, isobutoxyethoxy-2-propanol, 3-methyl-3-methoxybutanol, propylene glycol t-butyl ether, and mixtures of these solvents.

Suitable foam inhibitors or antifoams (=component E4) are, for example, soaps, paraffins or silicone oils, which can optionally be applied to carrier materials.

Suitable bases (=component E5) are alkali metal hydroxides, alkaline earth metal hydroxides, alkali metal carbonates, alkaline earth metal carbonates, ammonium carbonate, alkali metal hydrogencarbonates, alkaline earth metal hydrogencarbonates, ammonium hydrogencarbonates and mixtures thereof. Preference is given to using Na, Li and Mg carbonates and hydrogencarbonates, in particular sodium carbonate and/or odium hydrogencarbonate.

Additionally, the detergents, cleaners or dishwashing detergents according to the invention can comprise further additives E6), which further improve the application and/or aesthetic properties. As a rule, preferred compositions comprise, in addition to the aforementioned components, at least one further additive which is selected from electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, corrosion inhibitors, antistats, ironing aids, hydrophobizing and impregnation agents, swelling and slip-resist agents, and UV absorbers.

Suitable dye transfer inhibitors are especially homo- or copolymers comprising at least one copolymerized monomer selected from N-vinylpyrrolidone, N-vinylcaprolactam, N-vinylimidazole, 2-vinylpyridine, 4-vinylpyridine, salts of the three latter monomers, 4-vinylpyridine N-oxide, N-carboxymethyl-4-vinylpyridinium halides and mixtures thereof.

Suitable graying inhibitors and/or washing power boosters are especially:
carboxymethylcellulose,
graft polymers of vinyl acetate onto carbohydrates, for example onto degraded starch,
graft polymers of vinyl acetate onto polyethylene glycol,
alkoxylated oligo- and polyamines, e.g. ethoxylated hexamethylenediamine, which may additionally also be in quaternized and/or sulfated form, or alkoxylated polyethyleneimine with 16 to 24 EO per NH,
copolymers based on styrene and maleic acid which may additionally also have been modified with end group-capped polyethylene glycol,
copolymers based on styrene and acrylic acid.

In order to improve the aesthetic impression of the detergents, cleaners or dishwashing detergents according to the invention, they can be colored using suitable dyes. Preferred dyes, the selection of which does not present the person skilled in the art with any difficulty, have high storage stability and insensitivity to the other ingredients of the compositions and towards light, as well as no more substantivity towards textile fibers so as not to stain these.

The detergents, cleaners or dishwashing detergents according to the invention can contain at least one bitter substance (bitterant). Bitter substances are used in particular to prevent the ingestion of the compositions by children. Suitable bitter substances are known to a person skilled in the art. A preferred bitter substance is denatonium benzoate (phenylmethyl-[2-[(2,6-dimethylphenyl)amino]-2-oxoethyl]-diethylammonium benzoate), the most bitter chemical compound known, commercially available as Bitrex®.

### Dishwashing Compositions

The above-described multilayer films of the invention are also particularly advantageously suitable for at least partial coating or ensheathing of dishwashing detergents, especially of dishwashing detergents for machine dishwashing processes (automatic dishwashing, ADW). The polymer composition P1) present in the multilayer films exerts a dispersing, film-inhibiting, emulsifying and/or surfactant effect in dishwashing detergents. In addition, they ensure good rinse aid and/or drying performance. Examples of formulations of the invention for dishwashing include machine dishwashing compositions, rinse aids and machine dishwashing detergents with rinse aid function.

Machine dishwashing processes in the domestic and commercial sector comprise a plurality of successive steps, the first comprising the mechanical removal of loosely adhering food residues and the second the actual cleaning operation with the aid of a machine dishwasher, and the third generally consisting of a rinsing step, which is followed by the drying of the cleaned dishware. These operations are conducted in more or less automated form, the central unit used being a machine dishwasher in which at least the cleaning step and generally also the subsequent rinsing step and/or the drying step are conducted.

In machine dishwashers for the domestic sector, the soiled dishware is generally cleaned in a single chamber, and the aforementioned treatment steps proceed successively in a controlled program. Fresh water passes through the softening unit to the pump well and is sprayed by means of moving spray arms over the ware to be rinsed. Water-insoluble substances rinsed off are filtered out in the pump well. In the second rinse cycle, a generally alkaline cleaning composition is added to the rinse water, heated to the set temperature and distributed over the ware to be rinsed. In the last rinse cycle, a rinse aid is added to the treatment liquid, which reduces the surface tension, as a result of which the treatment liquid runs more easily off the ware. After the last rinse cycle, the contents are dried. The components used in the rinse cycle, such as water treatment agents, cleaning compositions, rinse aids, etc., can be used either in the form of individual components or in multicomponent formulations. Multifunctional detergents of this kind comprise surfactants for rinsing and a polymer for water softening. In that case, it is unnecessary to separately dispense a rinse aid and a salt for water softening into the machine dishwasher.

Commercial machine dishwashers consist basically of stationary bath tanks from which an essentially aqueous cleaning solution is jetted or sprayed onto the dishware, which moves past these baths on a conveyor belt, such that the used solution flows back into the bath tanks again. Water enters the last bath tank, flows via overflows in the manner of a cascade through all the other tanks and leaves the machine via the overflow of the first tank. The application of a generally highly alkaline cleaning solution generally takes place with the aid of nozzles provided therefor, or of a specific spraying system normally arranged in the middle region of the machine.

The multilayer films of the invention are suitable for at least partial coating or ensheathing of dishwashing compositions for machine dishwashing, which especially feature excellent film-inhibiting action. Preferred machine dishwashing composition formulations have inhibiting action with respect to both inorganic and organic film deposits. The inorganic film deposits are especially calcium and magnesium phosphate, calcium and magnesium carbonate, calcium and magnesium silicate and/or calcium and magnesium phosphonate, which arise from the calcium and magnesium salts present in the water and the builders present in standard dishwashing compositions. The organic film deposits are especially soil constituents from the rinse liquor, for example protein, starch and fat deposits. The formulations used in accordance with the invention for machine dishwashing are also effective against carry-over deposits, which originate from the residual water in the bottom of the machine dishwasher and comprise, inter alia, dishwashing composition residues and possibly also soil residues from the previous wash cycle of the machine dishwasher.

The dishwashing composition of the invention preferably comprises the following constituents:
Ga) at least one sheath and/or coating comprising or consisting of a multilayer film of the invention,
Gb) optionally at least one complexing agent,
Gc) at least one builder and/or cobuilder,
Gd) at least one nonionic surfactant,
Ge) optionally at least one component selected from bleaches, bleach activators and bleach catalysts,
Gf) optionally at least one enzyme,
Gg) optionally at least one further additive, preferably selected from anionic or zwitterionic surfactants, alkali carriers, polymeric dispersants, corrosion inhibitors, defoamers and foam inhibitors, dyes, fragrances, bitter substances, fillers, tablet disintegrants, organic solvents, tableting aids, disintegrants, thickeners and solubilizers,
Gh) optionally water.

A preferred dishwashing composition of the invention comprises:
Ga) 0.1% to 30% by weight of at least one sheath and/or coating comprising or consisting of a multilayer film of the invention,
Gb) 0% to 50% by weight of at least one complexing agent,
Gc) 0.1% to 80% by weight of at least one builder and/or cobuilder,
Gd) 0.1% to 20% by weight of at least one nonionic surfactant,
Ge) 0% to 30% by weight of at least one component selected from bleaches, bleach activators and bleach catalysts,
Gf) 0% to 8% by weight of at least one enzyme,
Gg) 0% to 50% by weight of at least one further additive, preferably selected from anionic or zwitterionic surfactants, alkali carriers, polymeric dispersants, corrosion inhibitors, defoamers and foam inhibitors, dyes, fragrances, bitter substances, fillers, tablet disintegrants, organic solvents, tableting aids, disintegrants, thickeners and solubilizers, and
Gh) 0% to 99.7% by weight of water,
   with the proviso that the weights of the components add up to 100% by weight.

With regard to suitable and preferred multilayer films Ga), reference is made to the general details relating to suitable and preferred multilayer films.

Complexing agents Gb) which may be used are, for example: nitrilotriacetic acid, ethylenediaminetetraacetic acid, diethylenetriaminepentaacetic acid, hydroxyethylethylenediaminetriacetic acid, methylglycinediacetic acid, glutamic acid diacetic acid, iminodisuccinic acid, hydroxyiminodisuccinic acid, ethylenediaminedisuccinic acid, aspartic acid diacetic acid, and also salts thereof in each case. Preferred complexing agents Gb) are methylglycinediacetic acid and glutamic acid diacetic acid and salts thereof.

Particularly preferred complexing agents Gb) are methylglycinediacetic acid and salts thereof, especially the mono-, di- and trisodium, -potassium, -lithium and -ammonium salts. The salts of methylglycinediacetic acid may be in racemic form, meaning that D and L enantiomers are present in an equimolar mixture, or one enantiomer, e.g. the L enantiomer, may be present in excess. Preference is given in accordance with the invention to 3% to 50% by weight of complexing agent Gb).

Builders and/or co-builders Gc) used may especially be water-soluble or water-insoluble substances having the main task of binding calcium and magnesium ions. These may be low molecular weight carboxylic acids and also salts thereof such as alkali metal citrates, in particular anhydrous trisodium citrate or trisodium citrate dihydrate, alkali metal succinates, alkali metal malonates, fatty acid sulfonates, oxydisuccinate, alkyl or alkenyl disuccinates, gluconic acids, oxadiacetates, carboxymethyloxysuccinates, tartrate monosuccinate, tartrate disuccinate, tartrate monoacetate, tartrate diacetate and α-hydroxypropionic acid.

A further substance class with cobuilder properties which may be present in the dishwashing compositions of the invention is that of the phosphonates. These are in particular hydroxyalkanephosphonates or aminoalkanephosphonates. Among the hydroxyalkanephosphonates, 1-hydroxyethane-1,1-diphosphonate (HEDP) is of particular significance as cobuilder. It is preferably used in the form of the sodium salt, the disodium salt giving a neutral reaction and the tetrasodium salt an alkaline reaction (pH 9). Suitable aminoalkanephosphonates are preferably ethylenediaminetetramethylenephosphonate (EDTMP), diethylenetriaminepentamethylenephosphonate (DTPMP) and the higher homologs thereof. They are preferably used in the form of the neutral sodium salts, for example as the hexasodium salt of EDTMP or as heptasodium and octasodium salts of DTPMP. The builder used in this case is from the class of the phosphonates, preferably HEDP. Aminoalkanephosphonates additionally have a pronounced heavy metal binding capacity. Accordingly, it may be preferable to use aminoalkanephosphonates, particularly DTPMP, or mixtures of the phosphonates mentioned, particularly if the compositions also comprise bleach.

Silicates may be used, inter alia, as builders. Crystalline sheet silicates having the general formula NaMSiₓO₂ₓ₊₁yH₂O may be present, where M is sodium or hydrogen, x is a number from 1.9 to 22, preferably from 1.9 to 4, particularly preferred values for x being 2, 3 or 4, and y is a number from 0 to 33, preferably 0 to 20. In addition, amorphous sodium silicates having an SiO₂:Na₂O ratio of 1 to 3.5, preferably 1.6 to 3 and in particular 2 to 2.8 may be used.

Furthermore, in the context of the dishwashing composition of the invention, builders and/or co-builders Gc) used may be carbonates and hydrogen carbonates, among which the alkali metal salts, particularly sodium salts, are preferred.

Furthermore, the cobuilders used may be homopolymers and copolymers of acrylic acid or methacrylic acid preferably having a weight-average molar mass of 2000 to 50 000 g/mol. Suitable comonomers are in particular monoethylenically unsaturated dicarboxylic acids such as maleic acid, fumaric acid and itaconic acid and also anhydrides thereof such as maleic anhydride. Also suitable are comonomers containing sulfonic acid groups such as 2-acrylamido-2-methylpropanesulfonic acid, allylsulfonic acid and methanesulfonic acid. Hydrophobic comonomers are also suitable, for example isobutene, diisobutene, styrene, alpha-olefins with 10 or more carbon atoms. Hydrophilic monomers having hydroxyl functions or alkylene oxide groups may also be used as comonomers. Examples include: allyl alcohol and isoprenol and also alkoxylates thereof and methoxypolyethylene glycol (meth)acrylate.

The dishwashing compositions of the invention preferably comprise builders and/or cobuilders Gc) in an amount of 5% to 80% by weight, more preferably 10% to 75% by weight, especially 15% to 70% by weight, more especially 15% to 65% by weight, based on the total weight of the dishwashing composition.

Suitable nonionic surfactants Gd) are, for example, weakly foaming or low-foaming nonionic surfactants. The dishwashing compositions of the invention comprise nonionic surfactants preferably in an amount of 0.1% to 20% by weight, more preferably of 0.1% to 15% by weight, especially of 0.25% to 10% by weight, especially of 0.5% to 10% by weight, based on the total weight of the dishwashing composition. Suitable nonionic surfactants include surfactants of the general formula (IX)

R³¹—O—(CH₂CH₂O)ₐ—(CHR³²CH₂O)_{b}—R³³ (IX),

in which R³¹ is a linear or branched alkyl radical having 8 to 22 carbon atoms, R³² and R³³ are each independently hydrogen or a linear or branched alkyl radical having 1 to 10 carbon atoms or H, where R³² is preferably methyl, and a and b are each independently 0 to 300. Preferably, a=1 to 100 and b=0 to 30.

Also suitable in the context of the present invention are surfactants of formula (X)

R³⁴—O—[CH₂CH(CH₃)O]_{c}[CH₂CH₂O]_{d}[CH₂CH(CH₃)O]ₑCH₂CH(OH)R³⁵ (X),

in which R³⁴ is a linear or branched aliphatic hydrocarbyl radical having 4 to 22 carbon atoms or mixtures thereof,
R³⁵ is a linear or branched hydrocarbyl radical having 2 to 26 carbon atoms or refers to mixtures thereof,
c and e have values between 0 and 40, and
d is a value of at least 15.

Also suitable in the context of the present invention are surfactants of formula (XI)

R³⁶O—(CH₂CHR³⁷O)_{f}(CH₂CH₂O)_{g}(CH₂CHR³⁸O)ₕ—CO—R³⁹ (XI),

in which
R³⁶ is a branched or unbranched alkyl radical having 8 to 16 carbon atoms,
R³⁷, R³⁸ are each independently H or a branched or unbranched alkyl radical having 1 to 5 carbon atoms,
R³⁹ is an unbranched alkyl radical having 5 to 17 carbon atoms,
f, h are each independently a number from 1 to 5, and
g is a number from 13 to 35.

The surfactants of the formulae (IX), (X) and (XI) may be either random copolymers or block copolymers; they are preferably block copolymers. Furthermore, in the context of the present invention, di- and multi-block copolymers constructed from ethylene oxide and propylene oxide can be used, which are commercially available, for example, under the name Pluronic® (BASF SE) or Tetronic® (BASF Corporation). Furthermore, reaction products of sorbitan esters with ethylene oxide and/or propylene oxide can be used. Amine oxides or alkyl glycosides are also suitable. An overview of suitable nonionic surfactants are disclosed in EP-A 851 023 and DE-A 198 19 187. Mixtures of two or more different nonionic surfactants may also be present. The dishwashing compositions of the invention may further comprise anionic or zwitterionic surfactants, preferably in a mixture with nonionic surfactants. Suitable anionic and zwitterionic surfactants are likewise specified in EP-A 851 023 and DE-A 198 19 187.

Bleaches and bleach activators Ge) used in connection with the dishwashing compositions of the invention may be representatives known to those skilled in the art. Bleaches are subdivided into oxygen bleaches and chlorine bleaches. Oxygen bleaches used are alkali metal perborates and hydrates thereof, and also alkali metal percarbonates. Preferred bleaches in this context are sodium perborate in the form of the mono- or tetrahydrate, sodium percarbonate or the hydrates of sodium percarbonate. Likewise useable as oxygen bleaches are persulfates and hydrogen peroxide. Typical oxygen bleaches are also organic peracids such as perbenzoic acid, peroxy-alpha-naphthoic acid, peroxylauric acid, peroxystearic acid, phthalimidoperoxycaproic acid, 1,12-diperoxydodecanedioic acid, 1,9-diperoxyazelaic acid, diperoxoisophthalic acid or 2-decyldiperoxybutane-1,4-dioic acid. In addition, the following oxygen bleaches can also be used in the dishwashing composition: cationic peroxy acids, which are described in the U.S. Pat. Nos. 5,422,028, 5,294,362 and 5,292,447, and sulfonylperoxy acids, which are described in the U.S. Pat. No. 5,039,447. Oxygen bleaches can be used in amounts of generally 0.1% to 30% by weight, preferably of 1% to 20% by weight, more preferably of 3% to 15% by weight, based on the overall dishwashing composition.

Chlorine bleaches and the combination of chlorine bleaches with peroxide bleaches can also be used in connection with the dishwashing compositions of the invention. Known chlorine bleaches are, for example, 1,3-dichloro-5,5-dimethylhydantoin, N-chlorosulfamide, chloramine T, dichloramine T, chloramine B, N,N′-dichlorobenzoyl urea, p-toluenesulfonedichloroamide or trichloroethylamine. Preferred chlorine bleaches in this case are sodium hypochlorite, calcium hypochlorite, potassium hypochlorite, magnesium hypochlorite, potassium dichloroisocyanurate or sodium dichloroisocyanurate. Chlorine bleaches in this connection can be used in amounts of 0.1% to 30% by weight, preferably of 0.1% to 20% by weight, preferably of 0.2% to 10% by weight, more preferably of 0.3% to 8% by weight, based on the overall dishwashing composition.

In addition, small amounts of bleach stabilizers, for example phosphonates, borates, metaborates, metasilicates or magnesium salts, may be added.

Bleach activators in the context of the present invention can be compounds which, under perhydrolysis conditions, give rise to aliphatic peroxocarboxylic acids having preferably 1 to 10 carbon atoms, in particular 2 to 4 carbon atoms, and/or substituted perbenzoic acid. In this case, suitable compounds comprise, inter alia, one or more N or O-acyl groups and/or optionally substituted benzoyl groups, for example substances from the class of the anhydrides, esters, imides, acylated imidazoles or oximes. Examples are tetraacetylethylenediamine (TAED), tetraacetylmethylenediamine (TAMD), tetraacetylglycoluril (TAGU), tetraacetylhexylenediamine (TAHD), N-acylimides such as N-nonanoylsuccinimide (NOSI), acylated phenol sulfonates such as n-nonanoyl- or isononanoyloxybenzenesulfonate (n- or iso-NOBS), pentaacetylglucose (PAG), 1,5-diacetyl-2,2-dioxohexahydro-1,3,5-triazine (DADHT) or isatoic anhydride (ISA). Also suitable as bleach activators are nitrile quats such as N-methylmorpholinium acetonitrile salts (MMA salts) or trimethylammonium acetonitrile salts (TMAQ salts). Preferred suitable bleach activators are from the group consisting of polyacylated alkylenediamines, more preferably TAED, N-acylimides, more preferably NOSI, acylated phenolsulfonates, more preferably n- or iso-NOBS, MMA, and TMAQ. Bleach activators in connection with the present invention can be used in amounts of 0.1% to 30% by weight, preferably of 0.1% to 10% by weight, preferably of 1% to 9% by weight, more preferably of 1.5% to 8% by weight, based on the overall dishwashing composition.

In addition to the conventional bleach activators or in place of them, so-called bleach catalysts may also be incorporated in rinse aid particles. These substances are bleach-enhancing transition metal salts or transition metal complexes such as salen complexes or carbonyl complexes of manganese, iron, cobalt, ruthenium or molybdenum. Also usable as bleach catalysts are complexes of manganese, iron, cobalt, ruthenium, molybdenum, titanium, vanadium and copper with nitrogen-containing tripod ligands and also amine complexes of cobalt, iron, copper and ruthenium.

As component Gf), the dishwashing compositions of the invention may comprise 0% to 8% by weight of enzymes. If the dishwashing compositions comprise enzymes, they comprise them preferably in amounts of 0.1% to 8% by weight. Enzymes may be added to the dishwashing composition in order to increase the cleaning performance or to ensure the same quality of cleaning performance under milder conditions (e.g. at low temperatures). The enzymes can be used in free form or a form chemically or physically immobilized on a support or in encapsulated form. The enzymes used most frequently in this context include lipases, amylases, cellulases and proteases. In addition, it is also possible, for example, to use esterases, pectinases, lactases and peroxidases. Preference is given in accordance with the invention to using amylases and proteases.

In connection with the dishwashing compositions of the invention, additives Gg) used may be, for example, anionic or zwitterionic surfactants, alkali carriers, polymeric dispersants, corrosion inhibitors, defoamers, dyes, fragrances, fillers, tablet disintegrants, organic solvents, tableting aids, disintegrants, thickeners, solubilizers or water. The alkali carriers used may be, for example, in addition to the ammonium or alkali metal carbonates already mentioned as builder substances, ammonium or alkali metal hydrogencarbonates and ammonium or alkali metal sesquicarbonates, and also ammonium or alkali metal hydroxides, ammonium or alkali metal silicates and ammonium or alkali metal metasilicates and also mixtures of the aforementioned substances.

The corrosion inhibitors used may be, inter alia, silver anticorrosives from the group of the triazoles, the benzotriazoles, the bisbenzotriazoles, the aminotriazoles, the alkylaminotriazoles and the transition metal salts or complexes.

To prevent glass corrosion, which is noticeable as cloudiness, iridescence, streaks and lines on the glasses, preference is given to using glass corrosion inhibitors. Preferred glass corrosion inhibitors are, for example, magnesium, zinc and bismuth salts and complexes and polyethyleneimines.

Paraffin oils and silicone oils may optionally be used in accordance with the invention as defoamers and to protect plastics and metal surfaces. Defoamers are used preferably in proportions of 0.001% by weight to 5% by weight. In addition, dyes, for example patent blue, preservatives, for example Kathon CG, perfumes and other fragrances may be added to the cleaning formulation of the invention.

An example of a suitable filler in connection with the dishwashing compositions of the invention is sodium sulfate.

Further possible additives that should be mentioned in connection with the present invention include amphoteric and cationic polymers.

In order to improve the aesthetic impression of the washing, cleaning or dishwashing compositions of the invention, they can be colored using suitable dyes. Preferred dyes, the selection of which presents no difficulty whatsoever to the person skilled in the art, have a high storage stability and insensitivity with respect to the other ingredients of the compositions and to light, and do not have any marked substantivity toward textile fibers, in order not to stain them.

### I & I Cleaners

The polymer films according to the invention are also suitable for industrial and institutional cleaners (I & I cleaners). (Industrial and institutional cleaners are typically detergents, all-purpose cleaners, foam cleaners, CIP cleaners (cleaning in place cleaners) for professional and generally automated cleaning operations, e.g. in industrial laundries, dairies, breweries, the food and drink industry, the pharmaceutical industry or pharmaceutical technology, or sanitary cleaners.

The cleaners can be strongly basic with a high electrolyte content and, if required, comprise bleaching agents (such as hydrogen peroxide, sodium hypochlorite) or disinfectants and antifoams (e.g. in bottle cleaning). It is also possible for the customary aforementioned enzymes to be present in the industrial and institutional cleaners. As regards the types of cleaning for which the formulations according to the invention are suitable, there is great variety. By way of example, mention may be made of cleaning baths (stationary or mobile), spray cleaning, ultrasound cleaning, steam jet cleaning and high-pressure cleaning, optionally in combination with mechanical cleaning, e.g. by rotating brushes.

The specified formulations for cleaning include those for industry, transport, commerce and industry and for the private sector. Specific examples include: professional laundries, professional cleaning businesses, ore processing industry, metal and metalworking industry, automobile and automobile supply industry, electrical industry, electronics industry, photographic industry and businesses, leisure industry and businesses, construction material industry, brewing industry and businesses; food industry (e.g. processing or production of meat, poultry, dairy and fish products), animal nutrition industry, cosmetics industry, pharmaceutical industry, agrochemical industry, gastronomy, the health sector, workshops, and public transport. Examples of objects to be cleaned are institutional laundry, hospital laundry, laundry from laundry collections, buildings with living spaces, office spaces or commercial spaces of a very wide variety of different kinds, and sanitary spaces, warehouses, breweries, small businesses such as bakeries, butcheries and supermarkets; hospitals, care homes, homes for the elderly, administration buildings, factory buildings, doctor's practices; and also motor vehicles (cars and trucks), buses, road tanker vehicles (interior and exterior), rail tanker wagons, passenger vehicles and goods vehicles, and aircraft and ships; also building facades, tiled or painted walls, floors made of wood (parquet, boards) with screed or textile or plastic coverings, signaling and lighting installations, furniture, railings, overhead signage, other signage, safety reflectors, delineating markers, tanks, dishes, glass panes, roads and paths, outside paving, road and railway tunnels.

The invention is illustrated in more detail by reference to the figures and examples described below. Here, the figures and examples should not be construed as being delimiting for the invention.

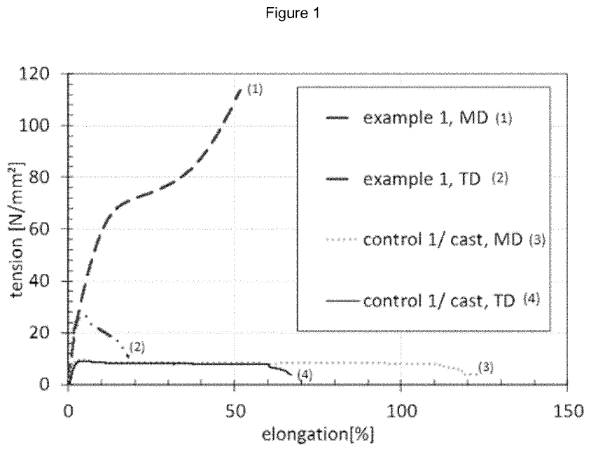

### BRIEF DESCRIPTION OF FIG. 1

FIG. 1 shows the tension vs elongation in machine direction (MD) and transverse machine direction (TD) for the comparative example 1 (control sample) (lines 3 and 4) and example 1 according to the invention (lines 1 and 2).

### EXAMPLES

The following abbreviations were used:

EO: ethylene oxide, PO: 1,2-propylene oxide,
PEO: polyethylene oxide

The weight-averaged molecular weight of the polymers was determined by gel permeation chromatography (GPC). The following instruments and chromatography methods were used for this purpose:

Standard: polyacrylic acid, neutralized
Eluent: 0.01 mol/I phosphate buffer (=10 Na₂HPO₄+1.8 KH₂PO₄+2.7 KCl+137 NaCl in mmol/1), pH=7.4, +0.01 M NaN₃ in deionized water
Flow rate: 0.8 ml/min
Column set: 2 separating columns (I=30 cm each)
Column temperature: 35° C.

### Detector: RID (Refractive Index Detector) Agilent 1200″

The following table 1 gives an overview of the commercial polyethylene oxide polymers P1) used in the examples.

TABLE 1

| | | | | Molecular |
|---|---|---|---|---|
| | | | | weight |
| P1) | Product name | Supplier | Abbreviation | [kg/mol] |
| 1 | Pluriol E9000 | BASF SE | PEG10K | 10 |
| 2 | POLYOX WSR N 10 | Dow Chemicals | PEO100k | 100 |
| 3 | POLYOX WSR 205 | Dow Chemicals | PEO600k | 600 |
| 4 | POLYOX WSR N 12 K | Dow Chemicals | PEO1mio | 1000 |
| 5 | PEO 2 mio mv | Sigma Aldrich | PEO2mio | 2000 |
| | Product: 372803 | | | |
| 6 | POLYOX WSR 301 | Dow Chemicals | PEO4mio | 4000 |

### Synthesis Example 1

Preparation of a polymer composition P2) with a molecular weight of 5330 g/mol from acrylic acid and a (C₅-C₁₈-alkyl)polyoxyalkylene ether with 7 ethylene oxide units per molecule in a weight ratio of 2:1. The initial charge was heated to 75° C. with stirring at 100 rpm. Then, feeds 1, 2 and 3 were metered in over 4 h and the reaction mixture was after-polymerized for a further hour. The mixture was then allowed to cool to room temperature. The polymer composition is produced in the form of a transparent and viscous solution.

| | | Amount | |
|---|---|---|---|
| | | (% by | Content |
| | Feed material | weight) | (%) |
| Initial | (C₈-C₁₈-Alkyl)polyoxyalkylene | 24.00 | 100.00 |
| charge | ether | | |
| | Water^{a)} | 18.00 | 100.00 |
| Feed 1 | Acrylic acid | 48.00 | 100.00 |
| Feed 2 | Initiator^{b)} | 0.34 | 100.00 |
| | Water^{a)} | 3.83 | 100.00 |
| Feed 3 | 2-Mercaptoethanol | 0.96 | 100.00 |
| | Sodium hypophosphite | 2.62 | 55.00 |
| | Water^{a)} | 2.25 | 100.00 |

^{a)}completely demineralized water
^{b)}2,2'-azobis(2-methylpropionamidine) dihydrochloride (CAS No. 2997-92-4)

The following table 2 gives an overview of the washing- and cleaning-active polymer compositions P2) and further tensides used as additives in the examples.

TABLE 2

| | | | | Abbre- |
|---|---|---|---|---|
| No. | Material | Product name | Supplier | viation |
| 1 | polymer P2) from | — | — | PASC |
| | synthesis example 1 | | | |
| 2 | vinylpyrrolidone-vinyl | Kollidon VA64 | BASF SE | PVP/VA |
| | acetate copolymer | Fine | | |
| | Mw: 65000 g/mol | | | |
| 3 | polyacrylic acid | Sokalan PA 25 | BASF SE | PAA |
| | Mw: 5000 g/mol | CL G | | |
| 4 | Carboxymethylcellulose | WALOCEL CRT | DOW | CMC |
| | sodium salt | 2000 PA | Chemical | |
| | | | Company | |
| 5 | C₁₃C₁₅-oxo alcohol | Lutensol AO7 | BASF SE | AO7 |
| | with 7 EO | | | |

### Tensile Strength Measurement:

Films were cut into samples with dimensions of 20 mm×50 mm and conditioned, i.e. measured after storage for more than 40 h at 50% relative humidity and 23° C. Tensile strength was measured using a Zwick Roell material tester at a constant grip separation rate of 25 mm/min in alignment with ASTMD882-12 standardized test procedure.

### Water Solubility:

The water-solubility of the polymer films was characterized using a standardized test method established by MonoSol LLC (MSTM-205, Monosol, Mar. 31, 2003). The time until first holes appear in the foil and the time until the foil completely separates from the slide support are subsequently referred to as disintegration time (t1) and release time (t2).

### Film Thickness:

Film thickness was measured using a digital micrometer indicator (ID-H0530, Mitutoyo).

### Comparative Example 1

As a control sample a polyethylene oxide film was prepared by a conventional film casting process. PEO600k was dissolved in deionized water by stirring over night at 40° C. The solution had a solid content of 10 wt. % and 0.5 wt. % Lutensol AO7 was added to improve wetting and reduce adhesion to the substrate. The polymer solution was knife coated on polyethylene terephthalate foil (Hostaphan RN100/100 μm) and dried by contact drying at 60° C. and ambient humidity. The obtained free standing polyethylene oxide foil was subsequently removed from the supporting polyethylene terephthalate substrate. The dry film thickness of the polyethylene oxide film was 64 μm and the dissolution times t1 and t2 (MonoSol method) were determined to be 15 s and 59 s, respectively.

### Example 1 (According to the Invention)

A polyethylene oxide film was prepared by low temperature calendaring of a polyethylene oxide powder to prepare a film. The PEO600k powder was dosed manually onto a continuous polyethylene terephthalate substrate (Hostaphan RN100/100 μm) and metered with a coating knife (ZUA 2000.60, Zehntner) with a 1.4 mm gap setting. The powder was fed horizontally into a single roll pair calendar (GK300L, Saueressig) exerting a linear force of 880 N/mm at a speed of 1 m/min. The calender rolls were temperature controlled at 40° C. The material exited the calender as continuous film and the supporting polyethylene terephthalate substrate and the polyethylene oxide film were seperated. To achieve the desired film thickness the polyethylene oxide film was then repeatedly calendered without supporting substrate at 1325 N/mm and a web speed of 1 m/min. After 3 calendaring steps, a film thickness of 63 μm was reached and the dissolutions times t1=12 sec and t2=60 sec were measured (MonoSol method).

1 shows a plot of the tension as a function of the elongation in machine direction (MD) and transverse maschine direction (TD) for comparative example 1 (control 1/cast film) and example 1 according to the invention (calendered film).

Whereas the comparative example shows significantly higher elongation at break (approx. 70% TD; approx. 120% MD), the film prepared according to the invention has a higher E-Modulus in the elastic range and a tensile strength that is orders of magnitude higher. The anisotropy shown by the difference in tensile strength in TD and MD indicates a strong orientation of the polymer film. Polymer chains are oriented due to shear forces caused by the deformation into a film. Once no more shear is applied, the oriented polymers may relax into a more isotropic state. The amount of orientation of the polymer and anisotropy in the final film depends on the absolute values of shear forces, the relaxation time and mobility during relaxation. The solid-state calendaring process according to the invention results in significantly higher shear forces due to the higher forces employed to deform the solid polymer. Polymer mobility is high while a cast film dries and a melt film solidifies. In contrast, relaxation is inhibited in solid state calendared films.

Table 3 summarizes values for tensile strength and elongation at break for conventionally produced films taken from U.S. Pat. No. 3,465,070 and compared to measured values for cast (comparative example 1) and solid state calendared films (example 1).

TABLE 3
Overview of mechanical properties of conventionally produced
PEO films compared to the solid state calendared films

| | | | Tensile | | Elongation | |
|---|---|---|---|---|---|---|
| | | | strength | | at | |
| | | | (Mpa) | | break (%) | |
| Source | Method | Material | MD | TD | MD | TD |
| US3465070 | extruded | 600 k | 21.9 | 13.9 | 596 | 557 |
| | | PEO | | | | |
| US3465070 | conventionally | 600 k | 14.8 | 13.4 | 958 | 888 |
| | calendered | PEO | | | | |
| US3465070 | cold rolled | 600 k | 57.8 | 16.0 | 290 | 858 |
| | from extruded | PEO | | | | |
| | foil | | | | | |
| comp. ex. 1 | cast | 600 k | 10.4 | 10.1 | 123 | 66 |
| | | PEO | | | | |
| example 1 | calendered in | 600 k | 101.0 | 24.1 | 51 | 18 |
| | solid state | PEO | | | | |

The combination of higher shear and less relaxation results in higher tensile strength, more anisotropic behavior, and lower elongation at break for the solid-state calendared films.

### Example 2: Molecular Weight

Films from polyethylene oxides with various molecular weights were prepared by the method described in Example 1. Tensile strength and weight averaged molecular weight is shown in table 4. As expected, tensile strength increases with molecular weight. All films were calendared using the same method and linear forces described in Example 1. To achieve a similar film thickness of 100 μm, the number of calendaring steps had to be varied with molecular weight. Whereas only 2 calendaring steps were necessary for MW≤600 kg/mol, 4 and 5 steps were required to reach 100 μm for Example 2D and 2E, respectively.

TABLE 4
Overview of tensile strength of
solid-state calendared PEO films
with variable molecular weight

| | Molecular | Tensile |
|---|---|---|
| | weight | strength |
| Example | kg/mol | MPa |
| Example 2A | 10 | 1.7 |
| Example 2B | 100 | 33.1 |
| Example 2C | 600 | 64.8 |
| Example 2D | 2000 | 129.3 |
| Example 2E | 4000 | 131.6 |

As shown in Table, tensile strength increases degressively with the molecular weight. Higher absolute values can be achieved for all materials if the number of calendaring steps or the linear force is further increased. Examples 2A to 2E show that the method according to the invention is applicable to PEO grades of various molecular weights.

### Example 3: Use of Functional Additives

In principle, no additives (such as tensides, softeners, etc.) are required to form water soluble foils from PEO by calendaring. It may however be desired to include at least one functional additive. As shown in Table, additivities is readily applicable to PEO/additive mixtures with various compositions. The weight content of PEO was kept constant at 20 wt. %. The calendaring procedure described in Example 1 was used.

TABLE 5
Overview of different functional additives introduced into PEO films.
Various mixtures of Polyacrylic acid (PAA), vinylpyrrolidone-vinyl
acetate copolymer (PVP/VA), Na-Carboxymethylcellulose (CMC) and
tenside (C₁₃C₁₅-oxo alcohol with 7 EO, Lutensol AO7) were added
to PEO and calendared into polymer films.

| | | Film | Tensile |
|---|---|---|---|
| | | thickness | strenght |
| Example | Composition | [μm] | N/mm² |
| Example 3A | 80% PAA, 20% PEO, +0.5% AO7 | 140 | 3.41 |
| Example 3B | 60% PAA, 20% PEO, 10% PVP/VA, | 80 | 2.75 |
| | 10% CMC | | |
| Example 3C | 60% PAA, 20% PEO, 10% PVP/VA, | 120 | 5.02 |
| | 10% CMC, +0.5% AO7 | | |

There is no intrinsic limitation to the mixing ratio between additive and polyethylene oxide. PEO content and tensile strength of various mixing ratios are shown in Table 5. Tensile strength reduces with PEO100k content from 7.7 MPa at 0.25 wt. % PEO to 3.7 MPa at 3.7 wt. %. Depending on the composition, the films may become opaque at high PEO content.

Here all mixtures were prepared using the calendaring method described in Example 1 with identical number of calendaring steps, whereas film thickness was not kept constant. Therefore, the higher molecular weight PEO films had a slightly higher film thickness but similar tensile strength compared to the PEO100k.

TABLE 1
Calendared films with various mixing ratios of Additive (PASC)
to Polyethylene oxide with a molecular weight of 100 kg/mol
(PEO100k) and 1000 kg/mol (PEO1mio).

| | | PEO | Tensile |
|---|---|---|---|
| | | content | strength |
| Experiment | Material | wt. % | MPa |
| Example 4A | PASC:PEO100k | 0.25 | 7.7 |
| Example 4B | PASC:PEO100k | 0.075 | 2.2 |
| Example 4C | PASC:PEO100k | 0.125 | 3.9 |
| Example 4D | PASC:PEO1mio | 0.075 | 2.4 |
| Example 4E | PASC:PEO1mio | 0.25 | 6.3 |
| Example 45 | PASC:PEO1mio | 0.125 | 3.7 |

### Comparison to Commercial Polyvinyl Alcohol Foil:

To show the applicability of the prepared films according to the invention in a unit dose packaging application commercial detergent capsules (DenkMit, DM Drogeriemarkt) were bought and the detergent fluent was removed. Pouches of calendared PEO foil were then prepared using a commercial heat sealing apparatus and filled with detergent fluid. The pouches were dissolved in a stirred beaker of demineralized water at 30° C. PEO600k pouches with a film thickness of 100 μm were dissolved after 20 min which is only 4 min slower compared to the commercial PVOH pouches (16 min). As rate of dissolution depends on film thickness as well as molecular weight of the PEO, the calendared PEO foil can be tuned to perform similar to commercial PVOH with respect to dissolution rate.

1. A process for producing a water-soluble or water-dispersible polymer film, comprising
a) providing a polymer composition in powder or granular form comprising a water-soluble ethylene oxide homo- or copolymer P1), and
b) subjecting the polymer composition provided in step a) to a calendering at a temperature below the melting point of the ethylene oxide homo- or copolymer P1) and substantially absent any extraneous solvent to obtain a polymer film.

2. The process according to claim 1, wherein the ethylene oxide homo- or copolymer P1) employed in step a) has a D50 value from 100 μm to 750 μm.

3. The process according to claim 1, wherein the ethylene oxide homo- or copolymer P1) employed in step a) has a number average molecular weight in the range from 10000 to 10000000 g/mol.

4. The process according to claim 1, wherein the polymer composition provided in step a) further comprises a polymer component P2) selected from the group consisting of
polymer compositions obtainable by free-radical polymerization of a monomer composition M) which comprises at least one monomer A) selected from the group consisting of α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether PE) having an average of 3 to 12 alkylene oxide units per molecule,
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from the group consisting of N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid,
copolymers comprising at least one copolymerized (meth)acrylic monomer selected from the group consisting of acrylic acid, methacrylic acid, salts thereof and mixtures thereof and at least one copolymerized hydrophobic monomer selected from the group consisting of C₁-C₈-alkyl esters of (meth)acrylic acid, C₂-C₁₀ olefins, styrene and α-methylstyrene,
copolymers comprising at least one copolymerized maleic monomer selected from the group consisting of maleic acid, maleic anhydride, maleic salts and mixtures thereof and at least one copolymerized C₂-C₈ olefin,
homo- and copolymers comprising at least one monomer comprising sulfonic acid groups,
homo- and copolymers of acrylamide and/or methacrylamide,
polyamino acids,
water-soluble or water-dispersible polyamides,
polyalkylene glycols, mono- or diethers of polyalkylene glycols, each being different from P1), and
mixtures thereof.

5. The process according to claim 1, wherein the polymer composition provided in step a) further comprises at least one additive.

6. The process according to claim 1, wherein the calendering in step b) is effected at a temperature in a range from 10 to 80° C.

7. The process according to claim 1, wherein the calendering in step b) is effected by exerting a linear force in a range of 50 to 5000 N/mm.

8. The process according to claim 1, wherein the calendering in step b) is effected at a speed in a range of 0.05 m/min to 1000 m/min.

9. A polymer film obtainable by a process as defined in claim 1.

10. A method of using the polymer film as defined in claim 9, the method comprising using the polymer film
as a washing and cleaning composition,
for at least partial coating or ensheathing of washing and cleaning compositions,
as a dishwashing composition or as a rinse aid,
for at least partial coating or ensheathing of dishwashing compositions or for at least partial coating or ensheathing of rinse aids,
as hygiene products,
for at least partial coating or ensheathing of hygiene products,
as disinfectants,
for at least partial coating or ensheathing of disinfectants,
for at least partial coating or ensheathing of personal care compositions,
for at least partial coating or ensheathing of personal cleansing compositions,
for at least partial coating or ensheathing of cosmetic compositions,
as pharmaceutical compositions,
for at least partial coating or ensheathing of pharmaceutical compositions,
as crop protection compositions,
for at least partial coating or ensheathing of crop protection compositions,
for at least partial coating or ensheathing of bait traps,
as food or animal feed packaging,
as wetting agents,
for at least partial coating or ensheathing of wetting agents,
as packaging for textiles,
as lamination films, or
in composite systems (laminates).

11. A sheath or coating for a washing composition portion, cleaning composition portion or dishwashing composition portion, comprising the polymer film as defined in claim 9.

12. A washing or cleaning composition comprising:
A) at least one sheath and/or coating comprising the polymer film as defined in claim 9,
B) at least one surfactant,
C) optionally at least one builder,
D) optionally at least one bleach system,
E) optionally at least one further additive, and
F) optionally water.

13. A dishwashing composition comprising:
Ga) at least one sheath and/or coating comprising the polymer film as defined in claim 9,
Gb) optionally at least one complexing agent,
Gc) at least one builder and/or cobuilder,
Gd) at least one nonionic surfactant,
Ge) optionally at least one component selected from the group consisting of bleaches, bleach activators and bleach catalysts,
Gf) optionally at least one enzyme,
Gg) optionally at least one further additive, and
Gh) optionally water.

14. The process according to claim 1, wherein the ethylene oxide homo- or copolymer P1) employed in step a) has a number average molecular weight in a range from 25000 to 5000000 g/mol.

15. The process according to claim 1, wherein the polymer composition provided in step a) further comprises a polymer component P2) selected from the group consisting of copolymers comprising at least one copolymerized acrylic monomer selected from the group consisting of acrylic acid, acrylic salts and mixtures thereof, and at least one copolymerized maleic monomer selected from the group consisting of maleic acid, maleic anhydride, maleic salts and mixtures thereof.

16. The process according to claim 1, wherein the polymer composition provided in step a) further comprises at least one additive selected from the group consisting of nonionic, anionic, cationic and amphoteric surfactants, polymeric dispersants, builders, complexing agents, bleaches, bleach activators, bleach catalysts, enzymes, enzyme stabilizers, bases, corrosion inhibitors, defoamers and foam inhibitors, wetting agents, dyes, pigments, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, antistats, ironing aids, hydrophobizing and impregnating agents, antiswell and antislip agents, plasticizers, scavengers, polymers other than the polymer component P1) and the polymer component P2), agents for modification of gas permeability and water vapor permeability, glidants, slip agents and UV absorbers and mixtures thereof.

17. The process according to claim 1, wherein the calendering in step b) is effected at a temperature in a range from 15 to 70° C.

18. The process according to claim 1, wherein the calendering in step b) is effected by exerting a linear force in a range of 100 to 2500 N/mm.

19. The washing or cleaning composition according to claim 12, wherein the optionally at least one further additive E) is selected from the group consisting of enzymes, bases, corrosion inhibitors, defoamers, dyes, fragrances, fillers, tableting aids, disintegrants, thickeners, solubilizers, organic solvents, electrolytes, pH modifiers, perfume carriers, fluorescers, hydrotropes, antiredeposition agents, optical brighteners, graying inhibitors, antishrink agents, anticrease agents, dye transfer inhibitors, antimicrobial active ingredients, antioxidants, polymeric dispersants, antistats, ironing aids, hydrophobizing and impregnating agents, antiswell and antislip agents and UV absorbers.

20. The dishwashing composition according to claim 13, wherein the optionally at least one further additive Gg) is selected from the group consisting of anionic or zwitterionic surfactants, alkali carriers, polymeric dispersants, corrosion inhibitors, defoamers, dyes, fragrances, fillers, tablet disintegrants, organic solvents, tableting aids, disintegrants, thickeners and solubilizers.
